(19) United States
(12) Patent Application Publication
(10) Pub. No.: US 2026/0160433 A1
(43) Pub. Date: Jun. 11, 2026

(54) AIR CONDITIONER

(71) Applicant: QINGDAO HISENSE HITACHI AIR-CONDITIONING SYSTEMS CO., LTD., Shandong (CN)

(72) Inventors: Haonan WANG, Qingdao (CN); Yixin JIANG, Xi'an (CN); Xiaomin LIU, Xi'an (CN); Tianen HU, Qingdao (CN); Fushuai GENG, Qingdao (CN)

(73) Assignee: QINGDAO HISENSE HITACHI AIR-CONDITIONING SYSTEMS CO., LTD., Shandong (CN)

(21) Appl. No.: 19/464,523

(22) Filed: Jan. 29, 2026

Related U.S. Application Data
(63) Continuation of application No. 19/426,088, filed on Dec. 19, 2025.
Application No. 19/426,088 is a continuation of application No. PCT/CN2024/085272, filed on Apr. 1, 2024.

(30) Foreign Application Priority Data
Jun. 19, 2023 (CN) 202310730929.9
Oct. 18, 2023 (CN) 202322803580.5
Oct. 30, 2023 (CN) 202311431001.7
Nov. 21, 2023 (CN) 202311559862.3

(51) Int. Cl. F24F 1/38; F04D 19/00; F04D 29/38; F04D 29/52

(52) U.S. Cl. CPC F24F 1/38; F04D 19/002; F04D 29/384; F04D 29/522

(57) ABSTRACT

An air conditioner includes a fan. The fan includes a fan blade, which includes a fixed portion and at least one blade. A first edge portion of the blade includes a first sub-edge portion, a second sub-edge portion, and a third sub-edge portion. The first sub-edge portion is disposed at an end of the first edge portion that is close to a windward side, the second sub-edge portion is disposed at an end of the first edge portion that is close to a leeward side, and the third sub-edge portion is connected between the first and second sub-edge portions. A distance between any point on the first sub-edge portion and the axis of the fixed portion is greater than a distance between any point on the second sub-edge portion and the axis of the fixed portion.

### CROSS-REFERENCE TO RELATED APPLICATION

This application is a Continuation application of U.S. patent application Ser. No. 19/426,088 filed on Dec. 19, 2025, which is a continuation of International Patent Application No. PCT/CN2024/085272 filed on Apr. 1, 2024 which claims priority to Chinese Patent Application No. 202311559862.3 filed on Nov. 21, 2023, Chinese Patent Application No. 202310730929.9 filed on Jun. 19, 2023, Chinese Patent Application No. 202311431001.7 filed on Oct. 30, 2023, and Chinese Patent Application No. 202322803580.5 filed on Oct. 18, 2023, the entire contents of which are incorporated herein by reference.

### TECHNICAL FIELD

The present disclosure relates to the field of air conditioning technologies, and in particular, to an air conditioner.

### BACKGROUND

An air conditioner mainly includes an outdoor unit and an indoor unit. An air outlet grille is arranged at an air outlet of the outdoor unit and mainly configured to avoid the external sundries enter the outdoor unit to influence normal operation of the outdoor unit, as well as to prevent users from directly contacting a fan inside the outdoor unit to cause an accident. In addition, airflow generated by the fan in the outdoor unit needs to reach the outside through the air outlet grille.

### SUMMARY

An air conditioner is provided. The air conditioner includes an indoor unit and an outdoor unit. The outdoor unit includes a housing, a fan and an air outlet grille. The housing includes a vent and an accommodating cavity, and the vent is in communication with the accommodating cavity. The fan is arranged in the accommodating cavity and corresponds to the vent. The air outlet grille includes a positioning portion, a supporting portion, at least one connecting portion and at least one first grille bar. The positioning portion is arranged at a rim of the air outlet grille and extends along a circumferential direction of the air outlet grille, and the positioning portion is connected to the housing and arranged close to the vent. The supporting portion is arranged coaxially with the air outlet grille and configured to support the air outlet grille. One end of the at least one connecting portion is connected to the supporting portion, and the other end of the at least one connecting portion faces the positioning portion and extends along a radial direction of the air outlet grille. The at least one first grille bar is provided between the positioning portion and the supporting portion and is connected to at least part of the at least one connecting portion; in an axial direction of the positioning portion, a size of the at least one first grille bar is defined as a first size, and a size of the at least one connecting portion is defined as a second size; the first size is greater than or equal to 6 mm, and a ratio of the first size to a minimum radial size of the positioning portion is any value in a first preset range; and a ratio of the second size to the minimum radial size of the positioning portion is any value in a second preset range.

### BRIEF DESCRIPTION OF THE DRAWINGS

FIG. 1 is a structural view of an air conditioner according to some embodiments;

FIG. 2 is a structural view of an outdoor unit according to some embodiments;

FIG. 3 is a structural view of an air outlet grille according to some embodiments;

FIG. 4 is a sectional view of the air outlet grille according to some embodiments;

FIG. 5 is a partial enlarged view of circle A in FIG. 4;

FIG. 6 is a partial enlarged view of circle B in FIG. 4;

FIG. 7 is a structural view of another air outlet grille according to some embodiments;

FIG. 8 is a structural view of still another air outlet grille according to some embodiments;

FIG. 9 is a structural view of still another air outlet grille according to some embodiments;

FIG. 10 is a partial structural view of an air outlet grille according to some embodiments;

FIG. 11 is a simulated effect graph of resistance of the air outlet grille to airflow according to some embodiments;

FIG. 12 is another simulated effect graph of the resistance of the air outlet grille to the airflow according to some embodiments;

FIG. 13 is a simulated effect graph of resistance of another air outlet grille to airflow according to some embodiments;

FIG. 14 is another simulated effect graph of the resistance of the another air outlet grille to the airflow according to some embodiments;

FIG. 15 is another sectional view of the air outlet grille according to some embodiments;

FIG. 16 is a partial enlarged view of circle C in FIG. 15;

FIG. 17 is still another partial structural view of the air outlet grille according to some embodiments;

FIG. 18 is a simulated effect graph of resistance of still another air outlet grille to airflow according to some embodiments;

FIG. 19 is a simulated effect graph of resistance of still another air outlet grille to airflow according to some embodiments;

FIG. 20 is a sectional view of the outdoor unit according to some embodiments;

FIG. 21 is a partial enlarged view of circle E in FIG. 20;

FIG. 22 is a relationship graph of an influence of a ratio of a minimum radial size of a positioning portion to a first radial size on an air quantity according to some embodiments;

FIG. 23 is a structural view of still another air outlet grille according to some embodiments;

FIG. 24 is another structural view of the still another air outlet grille according to some embodiments;

FIG. 25 is a sectional view taken along A-A in FIG. 24;

FIG. 26 is a partial enlarged view of circle M in FIG. 25;

FIG. 27 is a partial enlarged view of circle N1 in FIG. 26;

FIG. 28 is a partial enlarged view of circle N2 in FIG. 26;

FIG. 29 is a partial enlarged view of circle N3 in FIG. 26;

FIG. 30 is a line graph showing a relationship between a first included angle and a second included angle according to some embodiments;

FIG. 31 is a structural view of a first grille bar and a second grille bar according to some embodiments;

FIG. 32 is a line graph showing a relationship between a third included angle and a fourth included angle according to some embodiments;

FIG. 33 is a simulated effect graph of resistance of still another air outlet grille to airflow according to some embodiments;

FIG. 34 is another simulated effect graph of the resistance of still another air outlet grille to the airflow according to some embodiments;

FIG. 35 is still another simulated effect graph of the resistance of the still another air outlet grille to the airflow according to some embodiments;

FIG. 36 is still another simulated effect graph of the resistance of the still another air outlet grille to the airflow according to some embodiments;

FIG. 37 is still another simulated effect graph of the resistance of the still another air outlet grille to the airflow according to some embodiments;

FIG. 38 is still another simulated effect graph of the resistance of the still another air outlet grille to the airflow according to some embodiments;

FIG. 39 is a structural view of another air conditioner according to some embodiments;

FIG. 40 is a structural view of another outdoor unit according to some embodiments;

FIG. 41 is another structural view of the another outdoor unit according to some embodiments;

FIG. 42 is a structural view of a fan blade and a casing according to some embodiments;

FIG. 43 is a structural view of the fan blade according to some embodiments;

FIG. 44 is a structural view of the fan blade and an air guide portion according to some embodiments;

FIG. 45 is a partial enlarged view of circle F in FIG. 44;

FIG. 46 is a sectional view taken along line B-B in FIG. 44;

FIG. 47 is a partial enlarged view of circle G in FIG. 46;

FIG. 48 is a structural view of a fixed portion and a blade according to some embodiments;

FIG. 49 is another structural view of the fixed portion and the blade according to some embodiments;

FIG. 50 is a line graph showing a relationship between an air quantity and a rotating speed of a fan according to some embodiments;

FIG. 51 is a line graph showing a relationship between noise and a rotating speed of the fan according to some embodiments;

FIG. 52 is a line graph showing a relationship between the noise and the air quantity of the fan according to some embodiments;

FIG. 53 is a line graph showing a relationship between a power consumption and the air quantity of the fan according to some embodiments;

FIG. 54 is a structural view of another fan blade and the air guide portion according to some embodiments;

FIG. 55 is a structural view of the another fan blade according to some embodiments;

FIG. 56 is a structural view of another air guide portion according to some embodiments;

FIG. 57 is another structural view of the another fan blade and the air guide portion according to some embodiments;

FIG. 58 is a sectional view taken along line Q-Q in FIG. 57;

FIG. 59 is a partial enlarged view of circle W in FIG. 58;

FIG. 60 is a line graph showing a relationship between an air quantity and a rotating speed of another fan according to some embodiments;

FIG. 61 is a line graph showing a relationship between noise and the rotating speed of the another fan according to some embodiments;

FIG. 62 is a line graph showing a relationship between the noise and the air quantity of the another fan according to some embodiments; and

FIG. 63 is a line graph showing a relationship between power consumption and the air quantity of the another fan according to some embodiments.

### DESCRIPTION OF THE EMBODIMENTS

Some embodiments of the present disclosure are clearly and completely described below with reference to the accompanying drawings, and apparently, the described embodiments are not all but only a part of the embodiments of the present disclosure. All other embodiments obtained by a person of ordinary skill in the art based on the embodiments of the present disclosure shall fall within the protection scope of the present disclosure.

Unless required otherwise in the context, throughout the specification, the term “comprise” and its other forms such as “comprises” and “comprising” are interpreted as open and inclusive meaning “including, but not limited to”. In the description of the specification, the terms “one embodiment”, “some embodiments”, “exemplary embodiments”, “example”, “specific example”, “some examples”, or the like, are intended to indicate that a particular feature, structure, material, or characteristic in connection with the embodiment or example is included in at least one embodiment or example of the present disclosure. The schematic representations of the above terms do not necessarily refer to the same embodiment or example. In addition, the particular feature, structure, material, or characteristic may be included in any suitable manner in any one or more embodiments or examples.

Hereinafter, the terms such as “first” and “second” are used herein for purposes of description and are not intended to indicate or imply relative importance or significance or to imply the number of indicated technical features. Thus, the element defined with “first” and “second” may include one or more of this element explicitly or implicitly. In the description of the embodiments of the present disclosure, “a plurality” means two or more unless otherwise specified.

In describing some embodiments, the expressions “coupled” and “connected” along with their derivatives may be used. The term “connected” is to be interpreted broadly, and for example, “connected” may be a fixed connection, a detachable connection, or an integral connection; may be a direct connection or indirect connection via an intermediate medium. For example, the term “coupled” indicates that two or more components are in direct physical or electrical contact. The terms “coupled” or “communicatively coupled” may also mean that two or more components are not in direct contact with each other, but yet still cooperate or interact with each other. The embodiments disclosed herein are not necessarily limited to the contents herein.

“A and/or B” includes the following three combinations: A alone, B alone, and a combination of A and B.

The use of “adapted to” or “configured for” herein means open and inclusive languages and does not exclude devices adapted to or configured for performing additional tasks or steps.

An air conditioner, which is a relatively common household appliance, is widely used in daily life. The air conditioner includes an outdoor unit and an indoor unit, and the outdoor unit and the indoor unit cooperate to adjust a temperature of indoor air.

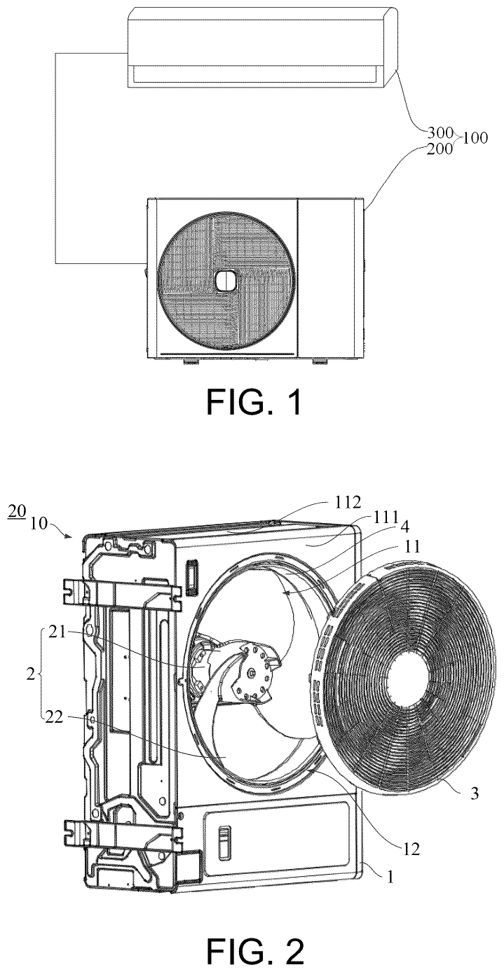

As shown in FIG. 1, in some embodiments, an air conditioner 100 includes an outdoor unit 200.

The outdoor unit 200 includes an outdoor heat exchanger, and the outdoor heat exchanger 30 is configured to perform one of liquefying and vaporizing on a refrigerant by heat exchange between the outdoor air and the refrigerant transferred in the outdoor heat exchanger 30.

The outdoor unit 200 further includes a compressor. The compressor is configured to compress a gas-phase refrigerant in a low-temperature and low-pressure state into a gas-phase refrigerant in a high-temperature and high-pressure state to assist the air conditioner 100 in performing a refrigerant cycle.

In some embodiments, the air conditioner 100 further includes an indoor unit 300. The indoor unit 300 includes an indoor heat exchanger, and the indoor heat exchanger is configured to perform the other of liquefying and vaporizing on the refrigerant by exchanging heat between indoor air and the refrigerant transferred in the indoor heat exchanger.

In some embodiments, the air conditioner 100 further includes an expansion valve configured to regulate a flow rate of the refrigerant within a pipe of the air conditioner 100.

The compressor, a condenser (the indoor heat exchanger or the outdoor heat exchanger), the expansion valves (an indoor expansion valve and an outdoor expansion valve), and an evaporator (the outdoor heat exchanger or the indoor heat exchanger) perform the refrigerant cycle of the air conditioner 100. The refrigerant cycle includes a series of processes involving compression, condensation, expansion, and evaporation, and circularly supplies the refrigerant to a conditioned side.

When the air conditioner 100 operates in a heating mode, the gas-phase refrigerant in the low-temperature and low-pressure state is compressed by the compressor into the gas-phase refrigerant in the high-temperature and high-pressure state, and the gas-phase refrigerant in the high-temperature and high-pressure state flows into the indoor heat exchanger. The indoor heat exchanger condenses the high-temperature and high-pressure gas-phase refrigerant into a liquid-phase refrigerant in a high-pressure state, and heat is released to a surrounding environment along with the condensation process, so that the temperature of the indoor air is increased. The expansion valve throttles and reduces a pressure of the liquid-phase refrigerant in the high-pressure state to form a gas-liquid two-phase refrigerant in a low-pressure state. The outdoor heat exchanger evaporates the gas-liquid two-phase refrigerant in the low-pressure state to form a low-temperature and low-pressure gas-phase refrigerant, and the gas-phase refrigerant in the low-temperature and low-pressure state returns to the compressor to form a heating cycle.

In the case where the air conditioner 100 operates in a cooling mode, the high-temperature and high-pressure gas-phase refrigerant discharged from the compressor flows into the outdoor heat exchanger. The outdoor heat exchanger condenses the high-temperature and high-pressure gas-phase refrigerant into a supercooled liquid-phase refrigerant in a medium-temperature and high-pressure state. The expansion valve throttles and reduces a pressure of the medium-temperature and high-pressure supercooled liquid-phase refrigerant to form a low-temperature and low-pressure gas-liquid two-phase refrigerant. The indoor heat exchanger evaporates the low-temperature and low-pressure gas-liquid two-phase refrigerant to form a low-temperature and low-pressure gas-phase refrigerant, and heat is absorbed from the surrounding environment in the evaporation process to reduce the temperature of the indoor air. The low-temperature and low-pressure gas-phase refrigerant returns to the compressor to form a cooling cycle.

In some embodiments, the outdoor unit includes an air outlet grille and a fan. The airflow formed by air subjected to heat exchange in the outdoor unit is blown out to an outdoor environment through the air outlet grille by the fan. The air outlet grille can avoid that foreign matter enters the outdoor unit to influence normal operation of the outdoor unit. The air outlet grille can also avoid direct contact between a user and the outdoor fan of the outdoor unit, thereby improving a safety performance of the outdoor unit.

Generally, in order to reduce a production cost, the air outlet grille of the outdoor unit is made of, for example, plastic, and at least one of parameters such as a height, thickness and length of a bar of the air outlet grille made of plastic is limited by a model process, so that an air outlet quantity of the air outlet grille is limited, that is, the air outlet grille generates large resistance to the airflow blown out by the fan. In this case, if an air outlet quantity requirement is to be met, a rotating speed of the fan needs to be increased, which may increase power of the fan, thus increasing an operation cost of the fan and reducing an energy efficiency ratio of the air conditioner.

In the related art, the resistance of the air outlet grille to the airflow blown out by the fan is usually reduced by adjusting radial or circumferential gaps between the bars of the air outlet grille. However, a width of the gaps between the bars in the air outlet grille needs to meet relevant standards. For example, a size of the gaps between the bars in the air outlet grille needs to be smaller than a preset size, so as to improve use reliability of the outdoor unit. Therefore, this way cannot effectively solve the problem that the air outlet grille generates large resistance to the airflow blown out by the fan.

In order to solve the above problem, the present disclosure provides an outdoor unit 20. In some embodiments, as shown in FIG. 2, the outdoor unit 20 includes a housing 1, and the housing 1 defines an accommodating cavity 11. An outdoor heat exchanger of the outdoor unit 20 is arranged in the accommodating cavity 11.

In some embodiments, the housing 1 includes a side wall 111. The side wall 111 includes four sub-side walls.

In some embodiments, the housing 1 further includes a top wall 112, the top wall 112 being connected to, for example, the four sub-side walls, or the top wall 112 being connected to, for example, three of the four sub-side walls.

In some embodiments, the housing 1 further includes a vent 12, the vent 12 being arranged, for example, in one of the four sub-side walls, or the vent 12 being arranged, for example, in the top wall 112. The vent 12 communicates the accommodating cavity 11 with an external structure.

In some embodiments, the housing 1 further includes an air inlet. For example, in the case where the vent 12 is arranged in one of the four sub-side walls, the air inlet is arranged in at least one of the remaining three sub-side walls. In the case where the vent 12 is arranged in the top wall 112, the air inlet is arranged in at least one of the four sub-side walls, for example.

In some embodiments, the outdoor unit 20 further includes a fan 2. The fan 2 is located in the accommodating cavity 11 and corresponds to the vent 12, and airflow formed by air subjected to heat exchange in the outdoor unit 20 is blown out to an outdoor environment by the fan 2. For example, an air outlet side of the fan 2 is arranged towards the vent 12 to drive the air to flow at the air inlet, the accommodating cavity 11 and the vent 12, so that the air flowing into the accommodating cavity 11 can fully exchange heat with the outdoor heat exchanger, and the air after heat exchange is discharged out of the accommodating cavity 11 through the vent 12.

In some embodiments, as shown in FIG. 2, the fan 2 includes a motor 21, and the motor 21 is arranged in the accommodating cavity and connected to the housing 1. For example, the motor 21 may be fixedly mounted on a side of the sub-side wall of the side wall 111 corresponding to the vent 12 by a fastener, the side facing the accommodating cavity 11.

As shown in FIG. 2, the fan 2 further includes at least one fan blade 22. The at least one fan blade 22 is connected to the motor 21 and arranged at intervals along an axial direction of the motor 21. The motor 21 is configured to drive the at least one fan blade 22 to rotate. In some embodiments, the at least one fan blade 22 is arranged in correspondence with the vent 12.

It will be appreciated that outdoor air is composed of a large number of particles (e.g., various gas molecules, dust, etc.) suspended in the air, and the large number of particles are free to move in the air without intervention of external forces.

In some embodiments, when the fan 2 runs, the at least one fan blade 22 rotates around a shaft of the motor 21 and impacts the particles in the air, and the impacted particles are transformed from free motion to rapid movement in a preset direction, thereby generating the airflow.

Air in front of the at least one fan blade 22 (for example, a side of the fan blade 22 facing the vent) is continuously blown away, and is blown out of the outdoor unit through the vent 12, so that a low air pressure region is formed in front of the at least one fan blade 22. In this case, an air pressure difference is formed between the front of the at least one fan blade 22 and the rear thereof (for example, a side of the fan blade 22 away from the vent), and under the action of the air pressure difference, air behind the at least one fan blade 22 flows towards the front thereof.

Since the at least one fan blade 22 continues to rotate, the at least one fan blade 22 blows out the air in front of the fan blade again, the air behind the at least one fan blade 22 flows to the front thereof again, and the process is repeated to form the continuous airflow.

In some embodiments, as shown in FIG. 2, the outdoor unit 20 further includes an air outlet grille 3. The air outlet grille 3 is arranged at the vent 12 and configured to cover the vent 12, and under the condition that the air outlet grille 3 covers the vent 12, the air outlet grille 3 is connected to the housing 1.

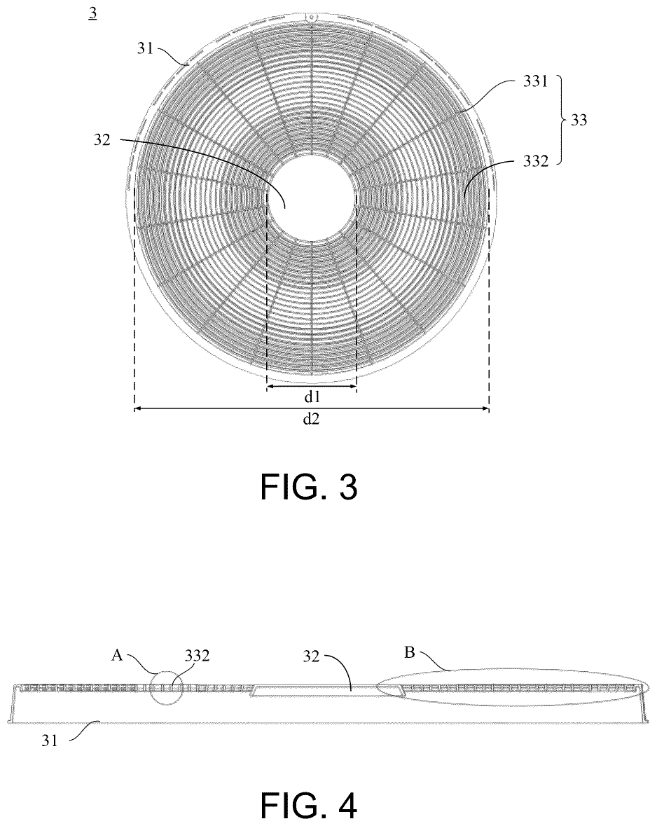

In some embodiments, as shown in FIG. 3 and FIG. 4, the air outlet grille 3 includes a positioning portion 31, and the positioning portion 31 extends along a circumferential direction of the air outlet grille 3 and is connected to a part of the housing 1 close to the vent 12. The positioning portion 31 is detachably arranged on a side of the housing 1 close to the vent 12, for example, by a fastener or in an engagement manner. The positioning portion 31 is configured to support and fix the air outlet grille 3.

In some embodiments, the air outlet grille 3 further includes a supporting portion 32, and the supporting portion 32 is arranged coaxially with the air outlet grille 3 and is arranged near a center of the positioning portion 31. The supporting portion 32 is configured to cooperate with the positioning portion 31 to support and fix the air outlet grille 3.

It should be noted that the positioning portion 31 has a shape of at least one of a circular ring, an elliptical ring, or a rectangular ring, for example. In the case where the positioning portion 31 has a shape of a circular ring, the center thereof is a circle center of the circular ring, and in this case, the supporting portion 32 is arranged near the circle center of the positioning portion 31; in the case where the positioning portion 31 has a shape of an elliptical ring, the center thereof is a center of the elliptical ring, and in this case, the supporting portion 32 is arranged near the center of the positioning portion 31. In the case where the positioning portion 31 has a shape of a rectangular ring, the center thereof is an intersection of two diagonal lines of the rectangular ring, and in this case, the supporting portion 32 is arranged near the intersection of the diagonal lines of the positioning portion 31.

In some embodiments, as shown in FIG. 3, the air outlet grille 3 further includes a grille mesh 33, and the grille mesh 33 includes a plurality of grille bars. The grille mesh 33 is arranged between the positioning portion 31 and the supporting portion 32, for example, the grille mesh 33 is connected to the positioning portion 31 and the supporting portion 32.

In some other embodiments, the supporting portion 32 and the grille mesh 33 are integrally formed, and the grille mesh 33 is connected to the positioning portion 31. In this way, the air outlet grille 3 has a simple structure and is convenient to manufacture and form.

In some embodiments, as shown in FIG. 3, the grille mesh 33 includes at least one connecting portion 331, one end of the at least one connecting portion 331 is connected to the positioning portion 31, and the other end towards the supporting portion 32 and extends along a radial direction of the air outlet grille 3. In the case where the at least one connecting portion 331 includes a plurality of connecting portions 331, the plurality of connecting portions 331 are arranged at intervals in a circumferential direction of the positioning portion 31. The at least one connecting portion 331 has, for example, a strip structure.

In some embodiments, the grille mesh 33 further includes at least one first grille bar 332, and the at least one first grille bar 332 is arranged between the positioning portion 31 and the supporting portion 32 and connected to at least part of the at least one connecting portion 331. The at least one first grille bar 332 extends in the circumferential direction of the positioning portion 31. In the case where the at least one first grille bar 332 includes a plurality of first grille bars 332, the plurality of first grille bars 332 are arranged at intervals in the radial direction of the air outlet grille 3. The plurality of first grille bars 332 are cross-connected to at least part of the at least one connecting portion 331 to form a grille bar layer of the grille mesh 33 away from the fan 2.

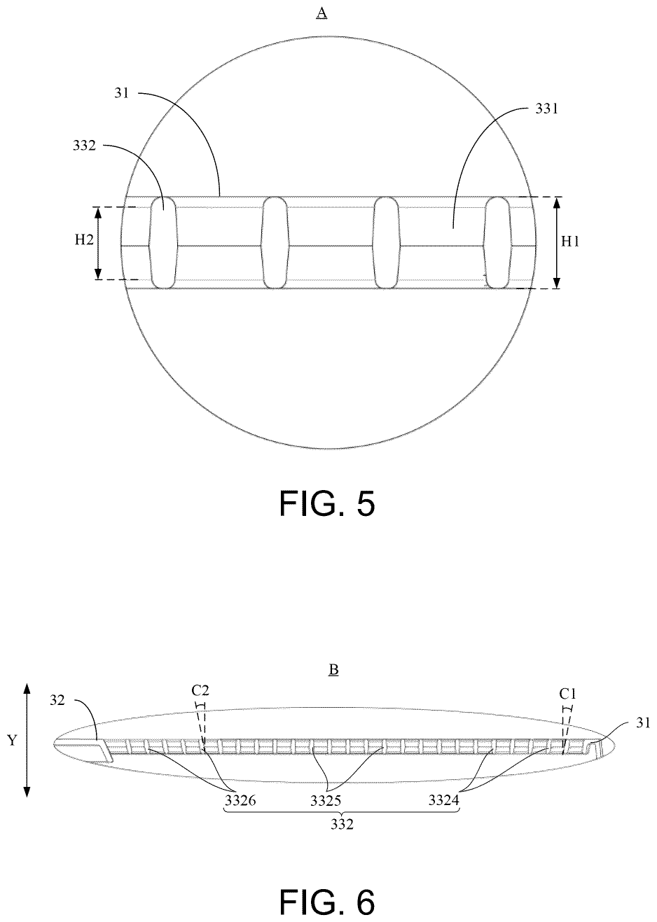

As shown in FIG. 4 and FIG. 5, in an axial direction of the positioning portion 31, a size of the at least one first grille bar 332 of the air outlet grille 3 is defined as a first size H1, and a size of the at least one connecting portion 331 is defined as a second size H2. The first size H1 satisfies: H1≥6 mm, so that a mold stripping requirement of the air outlet grille 3 can be ensured, and resistance of the at least one connecting portion 331 and the air outlet grille 3 to the airflow can be reduced.

In some embodiments, the first size H1 satisfies: 6 mm≤H1≤10 mm. In some embodiments, the first size H1 is any value of [6 mm, 8.4 mm]. For example, the first size H1 is 6 mm, 6.5 mm, 7 mm, 8 mm, or 8.4 mm.

In some embodiments, as shown in FIG. 3, a maximum radial size of the supporting portion 32 is defined as a first radial size d1, and a minimum radial size of the positioning portion 31 is defined as a second radial size d2.

In some embodiments, a ratio of the first size H1 to the second radial size d2 is any value in a first preset range, and the first preset range is [0.011, 0.014]. That is, the first size H1 and the second radial size d2 satisfy: 0.011≤H1/d2≤0.014.

In some embodiments, a ratio of the second size H2 to the second radial size d2 is any value in a second preset range, and the second preset range is [0.011, 0.014]. That is, the second size H2 and the second radial size d2 satisfy: 0.011≤H2/d2≤0.014.

In this way, in the case where the size of the air outlet grille 3 is determined, heights of the air outlet grille 3 and the at least one connecting portion 331 in the axial direction of the positioning portion 31 are reduced, so that a length of gaps in the grille mesh 33 in the radial direction of the positioning portion 31 can be reduced, the resistance of the air outlet grille 3 to the blown airflow can be reduced, operation power of the outdoor unit 20 can be reduced, and an operation cost of the outdoor unit 20 can be reduced.

In some embodiments, the second radial size d2 satisfies: 400 mm≤d2≤800 mm. For example, the second radial size d2 is 400 mm, 500 mm, 600 mm, 700 mm, or 800 mm.

In some embodiments, the second size H2 and the first size H1 satisfy: H2<H1, the end of the at least one connecting portion 331 away from the fan 2 is located at an end of the at least one first grille bar 332 away from the fan 2, and the end of the at least one connecting portion 331 close to the fan 2 is located at an end of the at least one first grille bar 332 close to the fan 2.

For example, in the case where the second size H2 is smaller than the first size H1 by 0.4 mm, a distance between an end surface of the end of the at least one connecting portion 331 away from the fan 2 and an end surface of the end of the at least one first grille bar 332 away from the fan 2 is 0.2 mm, and a distance between an end surface of the end of the at least one connecting portion 331 close to the fan 2 and an end surface of the end of the at least one first grille bar 332 close to the fan 2 is 0.2 mm. In this way, the connection between the at least one connecting portion 331 and the at least one first grille bar 332 may be tighter, increasing the structural strength of the air outlet grille 3.

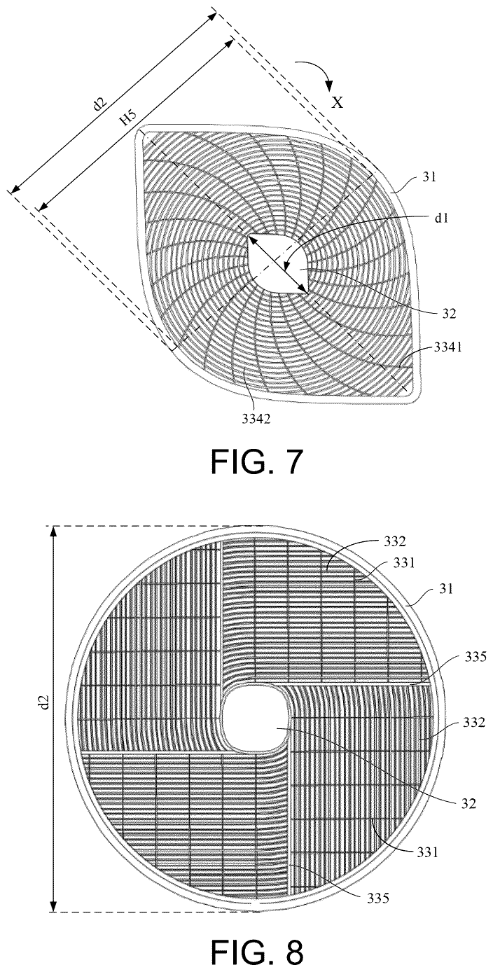

In some other embodiments, as shown in FIG. 7, the positioning portion 31 is an elliptical ring. The air outlet grille 3 includes at least one third grille bar 3341 and at least one fourth grille bar 3342. One end of the at least one third grille bar 3341 is connected to the supporting portion 32, the other end thereof extends towards the positioning portion 31 and is connected to the positioning portion 31. The at least one fourth grille bar 3342 protrudes in the circumferential direction (e.g., X direction in FIG. 7) of the air outlet grille 3. The at least one fourth grille bar 3342 is arranged around the center of the air outlet grille 3, and in the case where the at least one fourth grille bar 3342 includes a plurality of fourth grille bars 3342, the plurality of fourth grille bars 3342 are arranged at intervals in the radial direction of the air outlet grille 3. The at least one third grille bar 3341 is connected to the at least one fourth grille bar 3342.

Unlike the air outlet grille 3 in FIG. 3, the air outlet grille 3 in FIG. 7 includes a minor axis and a major axis. The minor axis is an axis in which the air outlet grille 3 has a shortest radial size, and the major axis is an axis in which the air outlet grille 3 has a longest radial size. In this case, a diameter of a smallest circumscribed circle of the supporting portion 32 of the air outlet grille 3 is defined as d1, and a diameter of a largest inscribed circle of a side of the positioning portion 31 close to the supporting portion 32 is defined as H5. A minor axis size of the positioning portion 31 is the second radial size d2 thereof.

In still other embodiments, as shown in FIG. 8, the positioning portion 31 is a circular ring, and the supporting portion 32 is arranged coaxially with the positioning portion 31. The air outlet grille 3 further includes at least one seventh bar 335. One end of the at least one seventh bar 335 is connected to the positioning portion 31, and the other end of the at least one seventh bar 335 is connected to the supporting portion 32, so that an enclosed region is formed between every two adjacent seventh bars 335.

As shown in FIG. 8, the at least one connecting portion 331 is a straight section. A part of the first grille bar 332 is a straight section, and the other part is an arc. In one enclosed region, the at least one connecting portion 331 and the first grille bar 332 are cross-connected. One end of the first grille bar 332 is connected to the positioning portion 31, and the other end is connected to the seventh bar 335. One end of the at least one connecting portion 331 is connected to the positioning portion 31, and the other end is connected to the seventh bar 335.

In this case, a diameter of the positioning portion 31 is the second radial size d2.

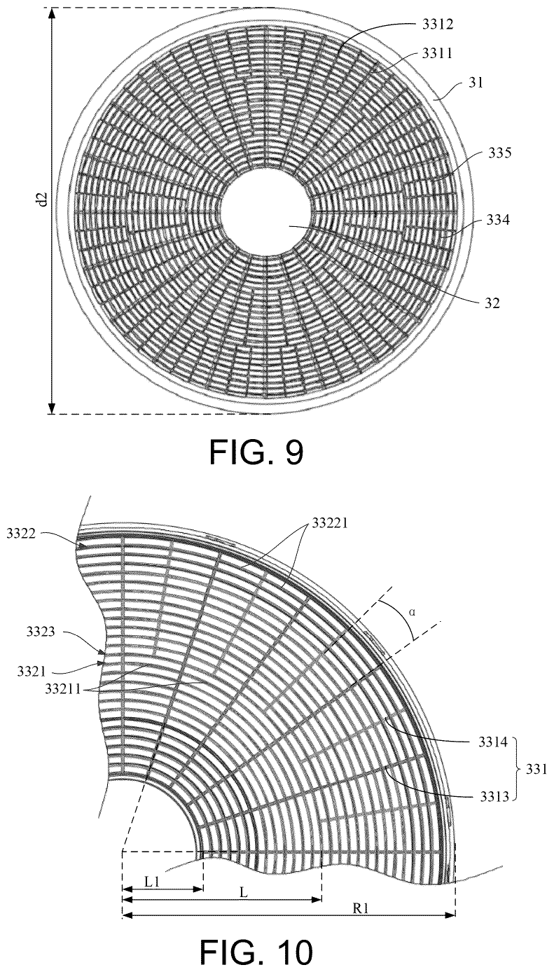

In still other embodiments, as shown in FIG. 9, the positioning portion 31 is a circular ring, and the supporting portion 32 is arranged coaxially with the positioning portion 31. The at least one connecting portion 331 includes at least one third sub-connecting portion 3311 and at least one fourth sub-connecting portion 3312. One end of the at least one third sub-connecting portion 3311 is connected to the positioning portion 31, and the other end extends along the radial direction of the air outlet grille 3 or extends at a preset included angle relative to the radial direction of the air outlet grille 3, and is connected to the supporting portion 32. In the case where the at least one third sub-connecting portion 3311 includes a plurality of third sub-connecting portions 3311, the plurality of third sub-connecting portions 3311 are uniform in length in the radial direction of the air outlet grille 3, and the plurality of third sub-connecting portions 3311 are arranged at intervals in the circumferential direction of the positioning portion 31 and connected to each of the first grille bars 332. In the case where the at least one fourth sub-connecting portion 3312 includes a plurality of fourth sub-connecting portions 3312, the plurality of fourth sub-connecting portions 3312 are arranged at intervals in the axial direction of the positioning portion 31 and connected to some of the first grille bars 332.

In this case, the diameter of the positioning portion 31 is the second radial size d2.

In some embodiments, as shown in FIG. 10, an included angle between extending directions of every two adjacent connecting portions 331 of the at least one connecting portion 331 is defined as α, and α satisfies: 7°≤α≤11°, for example, α is 70, 80, 90, 10° or 11°.

In this way, the connecting portion 331 can support the at least one first grille bar 332, so as to ensure that the at least one first grille bar 332 is not easily deformed in the radial direction thereof, and on the premise of meeting requirements of mold processing and mounting specifications, a number of the connecting portions 331 included in the air outlet grille 3 is reduced, thereby reducing the resistance of the connecting portion 331 to the airflow blown out by the outdoor fan 2.

It should be noted that the included angles between the extending directions of the adjacent connecting portions 331 may be equal or different. In some embodiments, the included angles between the extending directions of the adjacent connecting portions 331 are equal, that is, the plurality of connecting portions 331 are arranged at equal intervals in the circumferential direction of the positioning portion 31.

In some embodiments, as shown in FIG. 10, the at least one connecting portion 331 further includes at least one first sub-connecting portion 3313 and at least one second sub-connecting portion 3314, and the at least one first sub-connecting portion 3313 and the at least one second sub-connecting portion 3314 are sequentially arranged at intervals in the circumferential direction of the positioning portion 31. One end of the at least one first sub-connecting portion 3313 is connected to the positioning portion 31. The other end of the at least one first sub-connecting portion 3313 is connected to the supporting portion 32, and one of the following conditions is satisfied: the other end of the at least one first sub-connecting portion 3313 extends in the radial direction of the air outlet grille 3; or the other end of the at least one first sub-connecting portion 3313 extends at a preset included angle relative to the radial direction of the air outlet grille 3. One end of the at least one second sub-connecting portion 3314 is connected to the positioning portion 31, and the other end of the at least one second sub-connecting portion 3314 satisfies one of the following conditions: the other end of the at least one second sub-connecting portion 3314 extends in the radial direction of the air outlet grille 3; or the other end of the at least one second sub-connecting portion 3314 extends at a preset included angle relative to the radial direction of the air outlet grille 3. In addition, along a direction in which the at least one first sub-connecting portion 3313 and the at least one second sub-connecting portion 3314 extend, a length of the at least one first sub-connecting portion 3313 is greater than a length of the at least one second sub-connecting portion 3314.

One end of the at least one first sub-connecting portion 3313 is connected to the positioning portion 31, and the other end is connected to the supporting portion 32. One end of the at least one second sub-connecting portion 3314 is connected to the positioning portion 31, and the at least one second sub-connecting portion 3314 is cross-connected to at least part of the first grille bars 332.

In this way, it is possible to solve the problem that due to a small diameter of the first grille bar 332 close to the supporting portion 32, when the at least one connecting portion 331 is connected to the first grille bar 332, a gap between every two adjacent connecting portions 331 is small at a portion close to the supporting portion 32 and causes large resistance to the air blown out by the fan 2. Moreover, the resistance of the at least one connecting portion 331 to the airflow can be further reduced, and the resistance of the air outlet grille 3 to the airflow blown out by the fan 2 can be further reduced.

In some embodiments, a distance from an axis of the positioning portion 31 to an end of the second sub-connecting portion 3314 away from the positioning portion 31 is defined as a first distance L, a radius of the positioning portion 31 is defined as R1, and the first distance L satisfies: 0.55≤L/R1≤0.7. It should be noted that, as the minimum radial size R of the grille mesh 33 increases, a ratio of the first distance L to the radius of the positioning portion 31 (i.e., half of the minimum radial size R of the grille mesh 33) increases.

In this way, in the case where the radius R1 of the positioning portion 31 is determined, the length of the at least one second sub-connecting portion 3314 is determined by the above ratio, so that the gap between the at least one first grille bar 332 satisfies a relevant standard after the at least one second sub-connecting portion 3314 fits the at least one first sub-connecting portion 3313 and is fixedly connected to the first grille bar 332.

It should be noted that the included angle α between the extending directions of every two adjacent connecting portions 331 is an included angle between an extending direction of the first sub-connecting portion 3313 and an extending direction of the adjacent second sub-connecting portion 3314.

In some embodiments, in order to facilitate the arrangement of the at least one first grille bar 332, a distance between every two adjacent first grille bars 332 of the at least one first grille bar 332 in the radial direction thereof may be the same as a distance between the first grille bar 332 of the at least one first grille bar 332 close to the positioning portion 31 and the positioning portion 31 in the radial direction thereof.

In this way, a position of each first grille bar 332 may be determined by determining a positional relationship between the outermost first grille bar 332 of the plurality of first grille bars 332 between the positioning portion 31 and the supporting portion 32 and the positioning portion 31, and/or by determining a positional relationship between the outermost first grille bar 332 of the plurality of first grille bars 332 between the first grille bar 332 (of the at least one first grille bar 332 between the positioning portion 31 and the supporting portion 32) close to the positioning portion 31 and the circle center of the positioning portion 31 and the positioning portion 31.

In some embodiments, as shown in FIG. 10, the at least one first grille bar 332 includes a first bar 3321, and among the at least one first grille bar 332 between an end of the second sub-connecting portion 3314 away from the positioning portion 31 and the axis of the positioning portion 31, the first grille bar 332 close to the positioning portion 31 is the first bar 3321.

In some embodiments, the at least one first grille bar 332 further includes a second bar 3322, and among the at least one first grille bar 332 between the positioning portion 31 and the supporting portion 32, the first grille bar 332 close to the positioning portion 31 is the second bar 3322. The second bar 3322 is connected to each connecting portion 331.

In some embodiments, the at least one first grille bar 332 further includes a third bar 3323. The third bar 3323 is connected to an end of the second sub-connecting portion 3343 away from the positioning portion 31, and the third bar 3323 is adjacent to and spaced apart from the first bar 3321 in the radial direction of the grille mesh 33.

In some embodiments, as shown in FIG. 10, the first bar 3321 includes a first arc section 33211, and the first arc section 33211 is an arc of the first bar 3321 between two adjacent first sub-connecting portions 3313 of the at least one connecting portion 331.

An arc length of first arc section 33211 is defined as R2, and the arc length R2 satisfies: 0.15≤R2/R1≤0.2. It should be noted that the ratio of the arc length R2 to the radius R1 of the positioning portion 31 may increase as the radius R1 of the positioning portion 31 increases.

Therefore, after the radius R1 of the positioning portion 31 is determined, a range of the arc length R2 of the first arc section 33211 is determined by the above conditions. In this case, since a value of the included angle α between the extending directions of the two adjacent connecting portions 331 of the at least one connecting portion 331 is determined, a radius of the first arc section 33211, i.e., a radius of the first bar 3321 can be determined. Thus, a distance between the first bar 3321 and the positioning portion 31 can be determined, and thus a distance between any two adjacent first grille bars 332 can be determined.

In some other embodiments, as shown in FIG. 10, the second bar 3322 includes a second arc section 33221, and the second arc section 33221 is an arc of the second bar 3322 located between two adjacent connecting portions 331 of the at least one connecting portion 331, for example, between the adjacent first sub-connecting portion 3313 and second sub-connecting portion 3314.

An arc length of second arc section 33221 is defined as R3, and the arc length R3 satisfies: 0.15≤R3/R1≤0.2. It should be noted that the ratio of the arc length R3 to the radius of the positioning portion 31 may increase as the radius R1 of the positioning portion 31 increases.

When the radius R1 of the positioning portion 31 is determined, a range of the arc length R3 of the second arc section 33221 is determined by the above conditions, and in this case, since the included angle α between the extending directions of the two adjacent connecting portions 331 of the at least one connecting portion 331 is determined, a radius of the second arc section 33221 can be determined, a distance between the second bar 3322 and the positioning portion 31 can be determined, and the distance between any two adjacent first grille bars 332 can be determined.

The distance between two adjacent first grille bars 332 can be determined by calculating at least one of the ratio of the arc length R2 of the first arc section 33211 to the radius R1 of the positioning portion 31, or the ratio of the arc length R3 of the second arc section 33221 to the radius R1 of the positioning portion 31. In this way, under the condition that the air outlet grille 3 meets the requirements of the mold processing and mounting specification, the distance between any two adjacent first grille bars 332 can be increased, which facilitates the airflow blown out by the fan 2 to flow out of the air outlet grille 3, and reduces the resistance of the air outlet grille 3 to the airflow blown out by the fan 3.

In some embodiments, as shown in FIG. 6, the at least one first grille bar 332 further includes a fourth bar 3324, and the fourth bar 3324 is arranged adjacent to the positioning portion 31. An opening of an end of the fourth bar 3324 close to the fan 2 is smaller than that of an end thereof away from the fan 2, that is, a radial size of the fourth bar 3324 decreases in a direction away from the fan 2. In this way, the airflow flowing to the fourth bar 3324 can be guided conveniently, and the problem that the air quantity of the outdoor unit 20 is affected when the radial sizes of the plural first grille bars 332 are the same due to different air quantities of the airflow flowing to different positions on the grille mesh 33 and different air outlet directions is solved.

In this case, the radius of the at least one first grille bar 332 is defined as J, and a ratio of the radius of the at least one first grille bar 332 to the first distance L satisfies: 0.28≤J/L<0.44 That is, in the case where the ratio of the radius of the at least one first grille bar 332 to the first distance L is in the range of [0.28, 0.44), the radial size of at least part of the at least one first grille bar 332 close to the positioning portion 31 decreases in the direction away from the fan 2.

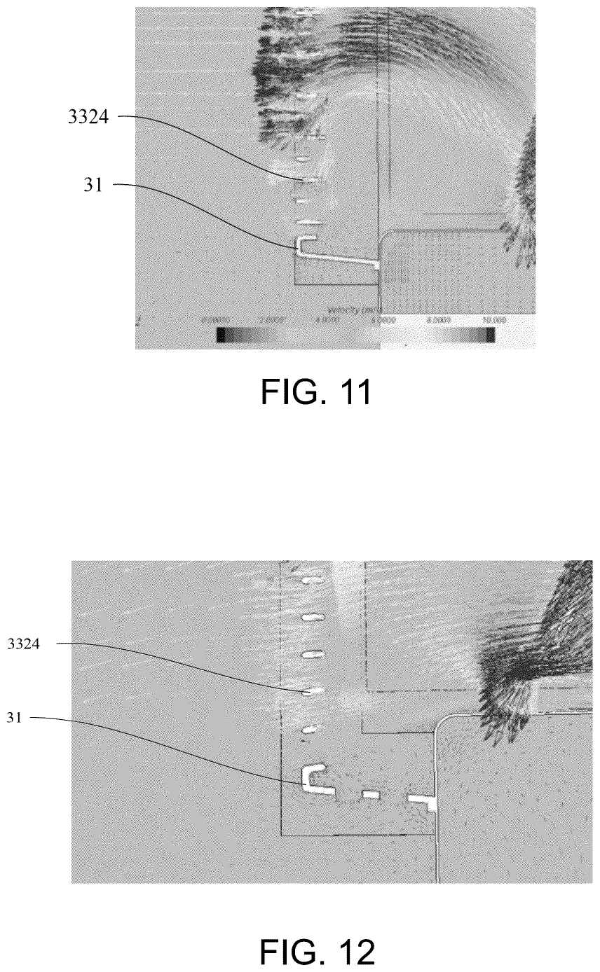

As shown in FIG. 11, when the radial size of the fourth bar 3324 is not adjusted, the airflow collides with the air outlet grille 3 at the fourth bar 3324 to generate a large vortex, so as to cause large resistance to the airflow.

As shown in FIG. 12, after the fourth bar 3324 is adjusted according to the above conditions, the airflow is guided by the fourth bar 3324, and the vortex generated by the airflow at the fourth bar 3324 is reduced, so that the airflow is subjected to smaller resistance at this position, and a flow speed is more stable.

In some embodiments, as shown in FIG. 6, the at least one first grille bar 332 further includes a fifth bar 3325. The fifth bar 3325 is located at a midpoint between the positioning portion 31 and the supporting portion 32 in the radial direction of the air outlet grille 3, and the airflow is smooth at this position, so that a radial size of the fifth bar 3325 is not changed in the direction away from the fan 2.

In this case, the ratio of the radius J of the at least one first grille bar 332 to the first distance L satisfies: 0.44≤J/L<0.78. That is, in the case where the ratio of the radius of the at least one first grille bar 332 to the first distance L is in the range of [0.44, 0.78), a radial size of the at least part of the at least one first grille bar 332 located at the midpoint between the positioning portion 31 and the supporting portion 32 in the radial direction of the air outlet grille 3 is not changed in the direction away from the fan.

In some embodiments, as shown in FIG. 6, the at least one first grille bar 332 further includes a sixth bar 3326. The sixth bar 3326 is located near the supporting portion 32, and an opening of an end of the sixth bar 3326 close to the fan 2 is larger than an opening of an end of the sixth bar 3326 away from the fan 2, that is, a radial size of the sixth bar 3326 increases in the direction away from the fan 2, so as to facilitate the sixth bar 3326 to guide the airflow flowing to the sixth bar 3326.

In this case, the ratio of the radius J of the at least one first grille bar 332 to the first distance L satisfies: J/L≥0.78. That is, in the case where the ratio of the radius of the at least one first grille bar 332 to the first distance L is greater than or equal to 0.78, a radial size of at least part of the at least one first grille bar 332 increases in the direction away from the fan 2.

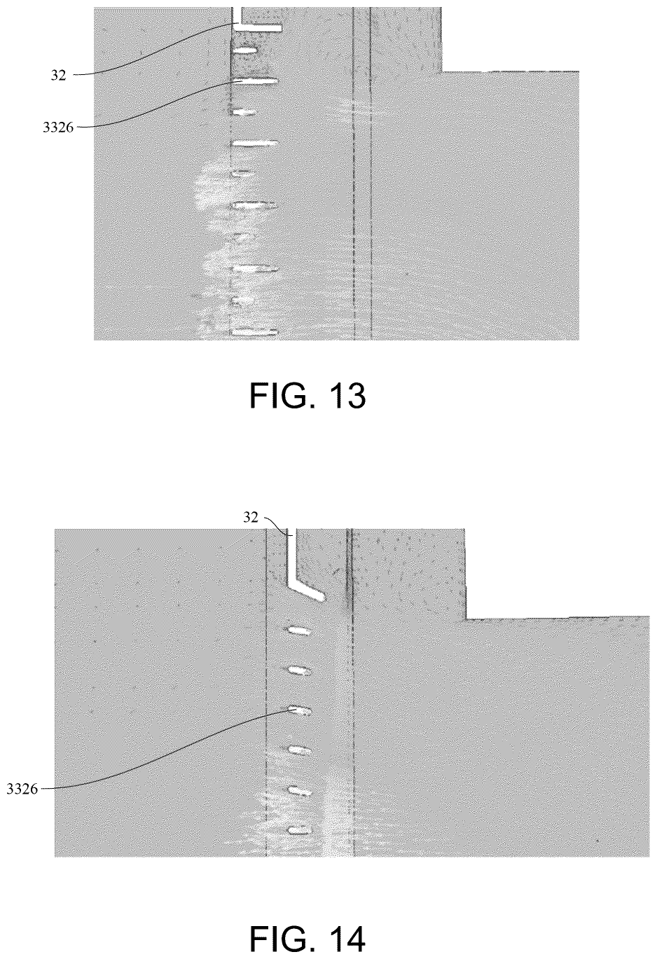

As shown in FIG. 13, when the radial size of the sixth bar 3326 is not adjusted, the airflow collides with the air outlet grille 3 seriously at the sixth bar 3326, and a vortex is generated at a position close to the supporting portion 32, thereby causing large resistance to the airflow.

As shown in FIG. 14, after the sixth bar 3326 is adjusted according to the above conditions, the airflow is guided by the sixth bar 3326, and the vortex generated by the airflow at the sixth bar 3326 is reduced, so that the airflow is subjected to smaller resistance at this position, and a flow speed is more stable.

It should be noted that in the case where J/L<0.28, the radius J of the at least one first grille bar 332 is smaller than the radius of the supporting portion 32. In this case, only the supporting portion 32 can be provided, and the at least one first grille bar 332 cannot be provided. When J/L is equal to 0.28, the at least one first grille bar 332 is fixed to a peripheral wall of the supporting portion 32.

In some embodiments, a projection of the axis of the at least one first grille bar 332 onto an inner wall thereof is a first straight section.

As shown in FIG. 6, in the case where 0.28≤J/L<0.44, that is, in the case where the first straight section is a projection of an axis of the fourth bar 3324 on an inner wall surface thereof, an included angle between an extension line of the first straight section and the axis of the at least one first grille bar 332 satisfies: C1=X1×(J/L), where X1 ranges from 75 to 160.

In this way, the airflow flowing to the fourth bar 3324 of the air outlet grille 3 can be better guided, so as to reduce the resistance of the air outlet grille 3 to the airflow blown out by the fan 2.

In some embodiments, in the case where J/L≥0.78, that is, in the case where the first straight section is a projection of an axis of the sixth bar 3326 on an inner wall surface of the sixth bar 3326, the included angle between the extension line of the first straight section and the axis of the at least one first grille bar 332 satisfies: C2=X2×(J/L), where X2 ranges from 50 to 64.

In this way, the airflow flowing to the sixth bar 3326 of the air outlet grille 3 can be better guided, so as to reduce the resistance of the air outlet grille 3 to the airflow blown out by the fan 2.

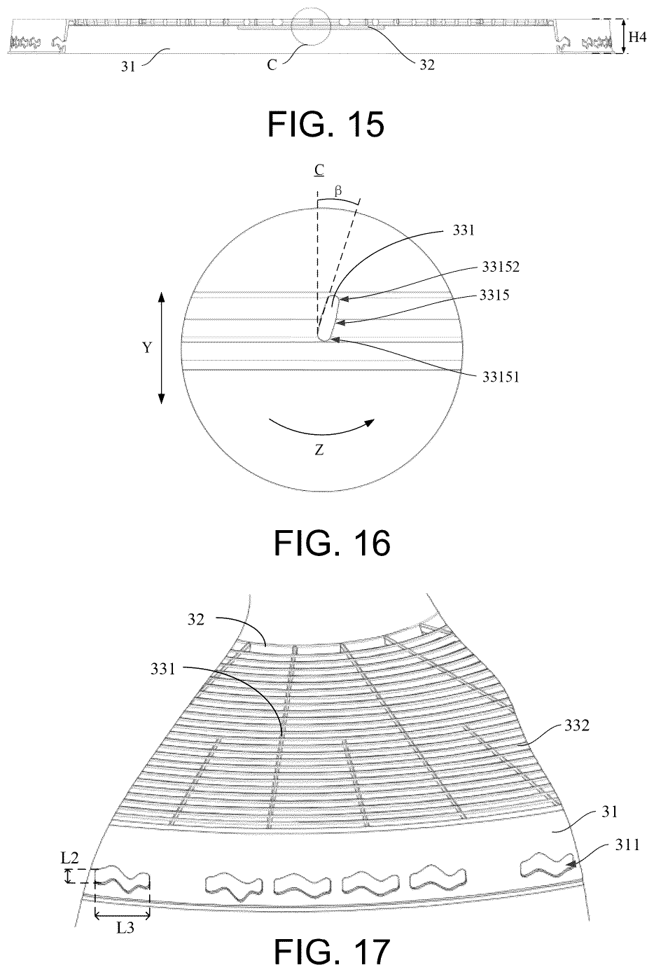

In some embodiments, as shown in FIG. 15 and FIG. 16, the at least one connecting portion 331 includes air guide surfaces 3315, and the air guide surfaces 3315 are facing side surfaces of two adjacent connecting portions 331 of the at least one connecting portion 331.

In some embodiments, as shown in FIG. 16, the air guide surface 3315 includes a first side edge 33151 and a second side edge 33152, and the second side edge 33152 is arranged on a side of the first side edge 33151 away from the fan 2.

In some embodiments, the air guide surface 3315 is perpendicular to an end surface of the positioning portion 31 facing the grille mesh 33 in the case where the rotating speed of the fan 2 is low.

In some embodiments, an included angle β is formed between the air guide surface 3315 and the end surface of the positioning portion 31 facing the grille mesh 33, that is, in the axial direction (e.g., direction Y in FIG. 16) of the positioning portion 31, the second side edge 33152 is located on a side of the first side edge 33151 away from the fan 2, and in a rotation direction (e.g., direction Z in FIG. 16) of the fan 2, the second side edge 33152 is located on a side of the first side edge 33151.

In some embodiments, the included angle β satisfies: 80°≤β<90°, for example, the included angle β may be 80°, 82°, 84°, 85°, 86°, or 89°. Thus, the air guide surface 3315 can facilitate guidance of the airflow blown from the fan 2, thereby reducing the resistance of the grille mesh 33 to the airflow blown out by the fan 2.

In some embodiments, as shown in FIG. 15, a size of the positioning portion 31 in the axial direction thereof is defined as a fourth size H4, and the fourth size H4 satisfies: 5 mm≤H4≤60 mm, for example, the fourth size H4 may be 5 mm, 10 mm, 20 mm, 30 mm, 40 mm, 50 mm, or 60 mm. Thus, the resistance of the positioning portion 31 to the airflow can be reduced.

It should be noted that, in the case where H4<5 mm, difficulty of producing the positioning portion 31 increases, and strength of the positioning portion 31 decreases, so that the positioning portion 31 is easily damaged during use.

In the case where H4>60 mm, since the grille mesh 33 is fixed to the end of the positioning portion 31 away from the fan 2, a distance between the grille mesh 33 and the fan 2 is large, and the airflow is excessively dispersed after blown onto the grille mesh 33, which increases the resistance to the airflow and a loss of the air quantity.

In some embodiments, as shown in FIG. 17, the positioning portion 31 includes at least one through hole 311, and the at least one through hole 311 is arranged on a side of the positioning portion 31 away from the fan 2. In this way, the airflow flowing to the positioning portion 31 can flow out through the at least one through hole 311 to further reduce the resistance of the positioning portion 31 to the airflow blown by the fan 2.

A maximum size of the at least one through hole 311 in the axial direction of the positioning portion 31 is defined as L2, and L2 satisfies: 0.023≤L2/R1≤0.027. That is, a ratio of the maximum size of the at least one through hole 311 in the axial direction of the positioning portion 31 to the radius of the positioning portion 31 is any value in [0.023, 0.027].

A maximum size of the at least one through hole 311 in the circumferential direction of the positioning portion 31 is defined as L3, and L3 satisfies: 0.09≤L3/R1≤0.1. That is, a ratio of the maximum size of the at least one through hole 311 in the circumferential direction of the positioning portion 31 to the radius of the positioning portion 31 is any value in [0.09, 0.1].

Thus, an area of the through hole 311 can be larger, facilitating the airflow to flow out from the at least one through hole 311.

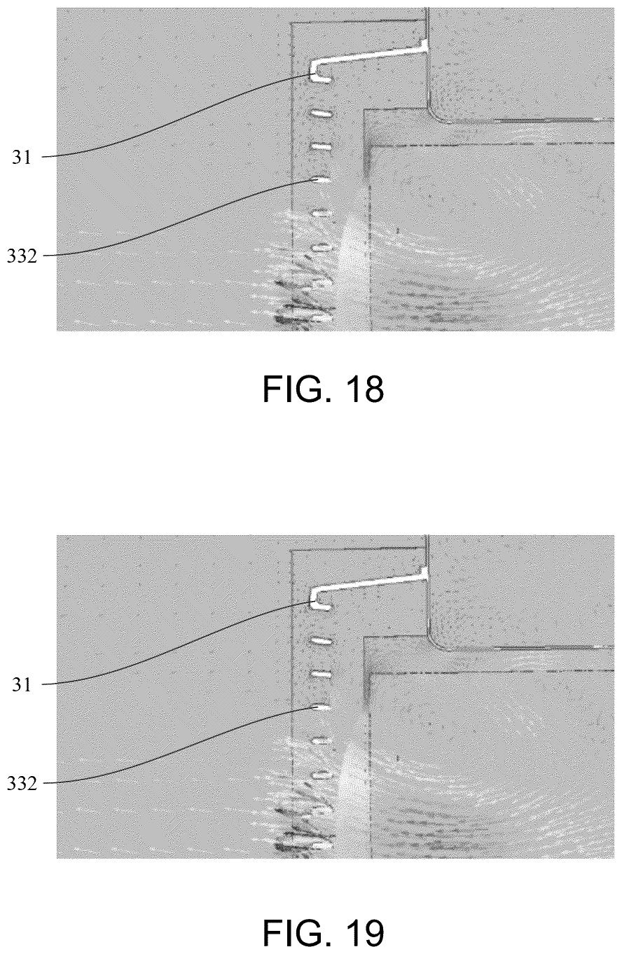

As shown in FIG. 18, in the case where the at least one through hole 311 is not formed on the side wall of the positioning portion 31 away from the fan 2, the airflow flowing to the positioning portion 31 is blocked by the positioning portion 31, and may collide with the positioning portion 31 and the at least one first grille bar 332 and the at least one connecting portion 331 near the positioning portion 31, thereby affecting the flow speed of the airflow at this position and causing resistance to flowing of the airflow at this position.

As shown in FIG. 19, in the case where the through hole 311 is formed in the positioning portion 31, the airflow flowing to the positioning portion 31 has reduced collision with the positioning portion 31 and the at least one first grille bar 332 and the at least one connecting portion 331 near the positioning portion 31. The flow speed of the airflow at this position is also improved, and the resistance of the positioning portion 31 to the airflow is reduced.

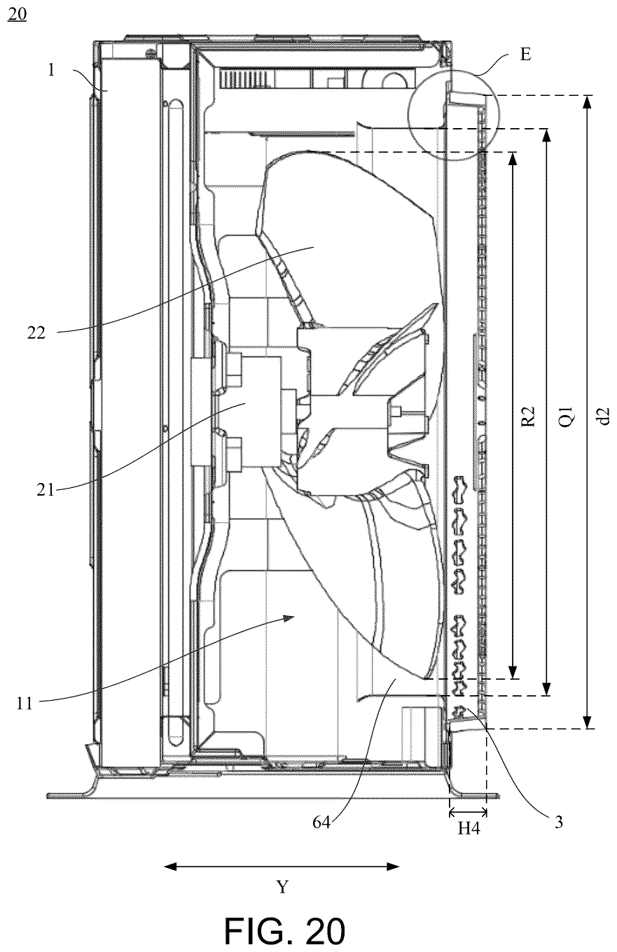

In some embodiments, as shown in FIG. 20, the outdoor unit 20 further includes an air guide portion 64, and the air guide portion 64 is arranged in the accommodating cavity 11 and located at the vent 12. The air guide portion 64 is connected to the housing 1 and extends along the whole circumference of the vent 12. The air guide portion 64 is configured to guide the airflow blown by the fan 2 to the vent 12 and the air outlet grille 3, so that the airflow can flow out of the housing 1 through the vent 12 and the air outlet grille 3.

In some embodiments, as shown in FIG. 20, the second radial size d2 and the minimum radial size Q1 of the air guide portion satisfy: 1≤d2/Q1≤1.25. Thus, the air guide portion 64 can guide the airflow blown out by the fan 2 to the air outlet grille 3, and an influence of the air guide portion 64 on the airflow blown out by the fan 2 can be reduced.

It should be noted that the positioning portion 31 is located at an edge of the air outlet grille 3, and a largest size of the grille mesh 33 in the radial direction thereof is the smallest radial size of the positioning portion 31.

In some embodiments, as shown in FIG. 22, under the condition that 1.05≤d2/d1≤1.15, an index of an increase amount of the airflow blown by the fan 2 onto the grille bar of the air outlet grille 3 is increased, so that after the airflow generated by the fan 2 is guided by the air guide portion 64 and blown onto the air outlet grille 3, a reduction effect on the resistance of the air outlet grille 3 is more obvious, and therefore the resistance of the air outlet grille 3 to the airflow blown by the fan 2 can be further reduced on the premise of controlling the production cost and ensuring the strength of the air outlet grille 3.

In some embodiments, when the second radial size d2 is increased and the minimum radial size Q1 of the air guide portion is unchanged, the second radial size d2 is increased relative to the minimum radial size Q1 of the air guide portion 64. Thus, a coverage area of the airflow guided by the air guide portion 64 and blown onto the air outlet grille 3 is not changed, and the area of the air outlet grille 3 is increased, so that a part of the airflow originally blown onto the edge of the air outlet grille 3 can be blown onto the grille mesh 33, and is blown out of the outdoor unit 20 through the grille mesh 33. In this way, the resistance of the positioning portion 31 to the airflow can be further reduced, thereby reducing the resistance of the air outlet grille 3 to the airflow blown out by the fan 2.

In some other embodiments, in the case where the second radial size d2 is unchanged and the minimum radial size Q1 of the air guide portion is reduced, the minimum radial size d2 of the positioning portion 31 is increased relative to the minimum radial size Q1 of the air guide portion 64. In this way, the coverage area of the airflow guided by the air guide portion 64 and blown to the air outlet grille 3 is reduced, and the area of the air outlet grille 3 is not changed, so that the part of the airflow originally blown to the edge of the air outlet grille 3 can be blown onto the grille bars of the air outlet grille 3 and blown out of the outdoor unit 20 through the gaps in the grille bars. In this way, the resistance of the positioning portion 31 to the airflow can be further reduced to reduce the resistance of the air outlet grille 3 to the airflow blown out by the fan 2.

In the case where the second radial size d2 of the positioning portion 31 is increased and the minimum radial size Q1 of the air guide portion is decreased, the minimum radial size d2 of the positioning portion 31 is increased relative to the minimum radial size Q1 of the air guide portion 64. In this way, the coverage area of the airflow guided by the air guide portion 64 and blown to the air outlet grille 3 is reduced, and the area of the air outlet grille 3 is increased, so that the part of the airflow originally blown to the edge of the air outlet grille 3 can be blown onto the grille bars of the air outlet grille 3 and blown out of the outdoor unit 20 through the gaps in the grille bars. In this way, the resistance of the positioning portion 31 to the airflow can be further reduced to reduce the resistance of the air outlet grille 3 to the airflow blown out by the fan 2.

TABLE 1

| | Size parameter | | | | | | |
|---|---|---|---|---|---|---|---|
| | Minimum radial | | | | Performance parameter | | |
| | size Q1 of | | | Fourth | Air | | |
| | the air guide | Second radial | Diameter | size | quantity | Rotating | |
| | portion/mm | size d2/mm | R3/mm | H4/mm | m³/h | speed/rpm | Noise/dB |
| Solution 1 | 616 | 630 | 600 | 30 | 4626 | 681 | 56.8 |
| Solution 2 | 616 | 670 | 600 | 30 | 4626 | 634 | 54.7 |

Table 1 is a table comparing size parameters with performance parameters of the outdoor unit in some embodiments. As shown in table 1, a size relationship between the air guide portion 64 and the air outlet grille 3 is simulated, and in some embodiments, solutions 1 and 2 are provided. The minimum radial size Q1 of the air guide portion 64 in the solution 1 is equal to the minimum radial size Q1 of the air guide portion 64 in the solution 2, and the minimum radial size d2 of the positioning portion 31 in the solution 1 is smaller than the minimum radial size d2 of the positioning portion 31 in the solution 2 by 40 mm. In this case, d2/Q1 in the solution 2 is about 0.088, d2/Q1 in the solution 1 is about 0.023, and d2/Q1 in the solution 2 is greater than d2/Q1 in the solution 1 by 0.065.

Air outlet quantities of the outdoor units 20 reach the same value, for example, 4,626 m³/h. In this case, the rotating speed of the fan 2 in the solution 1 is 681 rpm, and the rotating speed of the fan 2 in the solution 2 is 634 rpm. That is, in order to achieve the same air outlet quantity, the rotating speed of the fan 2 required by the solution 2 is lower than the rotating speed of the fan 2 required by the solution 1 by 47 rpm. In this case, the noise generated by the outdoor unit 20 of the solution 1 is 56.8 dB, the noise generated by the outdoor unit 20 of the solution 2 is 54.7 dB, and the noise generated by the outdoor unit 20 of the solution 2 is lower than the noise generated by the outdoor unit 20 of the solution 1 by 2.1 dB.

As can be seen from table 1, when a diffusion range of the airflow blown out of the air guide portion 64 is not changed, the increase of the minimum radial size d2 of the positioning portion 31 relative to the minimum radial size Q1 of the air guide portion 64 can reduce the loss of the air outlet quantity caused by the air outlet grille 3, and when the outdoor unit 20 achieves the same air outlet quantity and obtains the same heat exchange efficiency, the required rotating speed of the fan 2 is lower, the generated noise is lower, improving the experience of a user for the outdoor unit 20.

A diameter of a largest circle formed by rotation of the fan blade 22 is R3 which is 600 mm, a size of the positioning portion 31 of the air outlet grille 3 in an axial direction of the vent 12 is H4 which is 30 mm, and the minimum radial size Q1 of the air guide portion 64, the diameter R3 of the largest circle formed by the rotation of the fan blade 22, and the size H4 of the positioning portion 31 of the air outlet grille 3 in the axial direction of the vent 12 in the solution 2 are kept the same as those in the solution 1.

It can be understood that the airflow generated by the fan 2 is guided by the air guide portion 64 and blown onto the air outlet grille 3, and the resistance of the air outlet grille 3 is reduced, so that the loss of the air quantity is reduced, and the air quantity of the outdoor unit 20 is increased, thereby improving the heat exchange efficiency of the outdoor unit 20.

In some embodiments, as shown in FIG. 20, in the case where d2 and Q1 satisfy: d2/Q1<1, that is, the minimum size of the positioning portion 31 in the radial direction thereof is smaller than the minimum radial size of the air guide portion 64, and the positioning portion 31 is arranged at the vent 12, a size of the vent 12 matches the size of the positioning portion 31, and therefore, a minimum radial size of the vent 12 in the radial direction thereof is smaller than the minimum radial size of the air guide portion 64. In the process that the air blown out by the fan 2 flows to the air outlet grille 3, a part of the air is blown on an inner wall of the accommodating cavity 11 of the housing 1, and the other part of the air is blown on the air outlet grille 3, so that the air blown on the inner wall of the accommodating cavity 11 of the housing 1 cannot be blown out through the housing 1, and the resistance to the air blown out by the fan 2 is increased, thereby increasing the loss of the air quantity and reducing the air quantity.

In the case where d2 and Q1 satisfy: d2/Q1>1.25, that is, the minimum size of the positioning portion 31 in the radial direction thereof is greater than the minimum radial size of the air guide portion 64, as the minimum size of the positioning portion 31 in the radial direction thereof increases relative to the minimum radial size of the air guide portion 64, the quantity of the air that can be blown out from the gap on the grille mesh of the air outlet grille 3 does not increase any more, the quantity of the air that is blown to a position of the air outlet grille 3 near the positioning portion 31 does not decrease any more, and there is no significant effect on reducing the resistance of the air outlet grille 3 to the air; moreover, the production cost of the air outlet grille 3 is increased and the strength of the air outlet grille is reduced.

In some embodiments, as shown in FIG. 20, when the ratio of the second radial size d2 to the minimum radial size Q1 of the air guide portion 64 is greater than or equal to 1.05 and less than or equal to 1.15, the index of the increase in the quantity of the air blown onto the air outlet grille 3 by the fan 2 is increased, so that after the air generated by the fan 2 is guided to the air outlet grille 3 by the air guide portion 64, the reduction effect on the resistance of the air outlet grille 3 is more obvious, and the resistance of the air outlet grille 3 to the air blown by the fan 2 is reduced on the premise of controlling the production cost and ensuring the strength of the air outlet grille itself.

In some embodiments, as shown in FIG. 20, the motor 21 drives the at least one fan blade 22 to rotate, and a diameter of a largest circle formed by rotation of a point of the at least one fan blade 22 around the axis of the fan 20 is defined as R3, the point being farthest from the axis of the outdoor fan 20. R3 and Q1 satisfy: 1.02≤Q1/R3≤1.1, and q1−R3≥12 mm. Thus, the diameter R3 of the largest ring formed by the rotation of the at least one fan blade 22 is smaller than the minimum radial size Q1 of the air guide portion 64, so as to meet an assembly requirement of the at least one fan blade 22, and the at least one fan blade 22 can be mounted in the air guide portion 64 and does not collide with the air guide portion 64 during operation. The airflow generated by the at least one fan blade 22 is not excessively dispersed, so that the airflow generated by the fan 20 does not excessively collide with the air guide portion 64, the housing 10 and the air outlet grille 3, and the resistance received by the airflow and the loss of the air quantity are reduced.

Under the condition that R3 and Q1 satisfy: Q1/R3<1.02, the at least one fan blade 22 cannot be mounted in the air guide portion 64, so that the assembly requirement of the at least one fan blade 22 cannot be met.

Under the condition that R3 and Q1 satisfy: Q1/R3>1.1, the diameter R3 of the largest circle formed by rotation of the at least one fan blade 22 is smaller than the minimum radial size Q1 of the air guide portion, so that the airflow generated by the at least one fan blade 22 is excessively dispersed, the airflow generated by the at least one fan blade 22 excessively collides with the air guide portion 64, the housing 1 and the air outlet grille 3, and the resistance received by the airflow and the loss of the air quantity are increased.

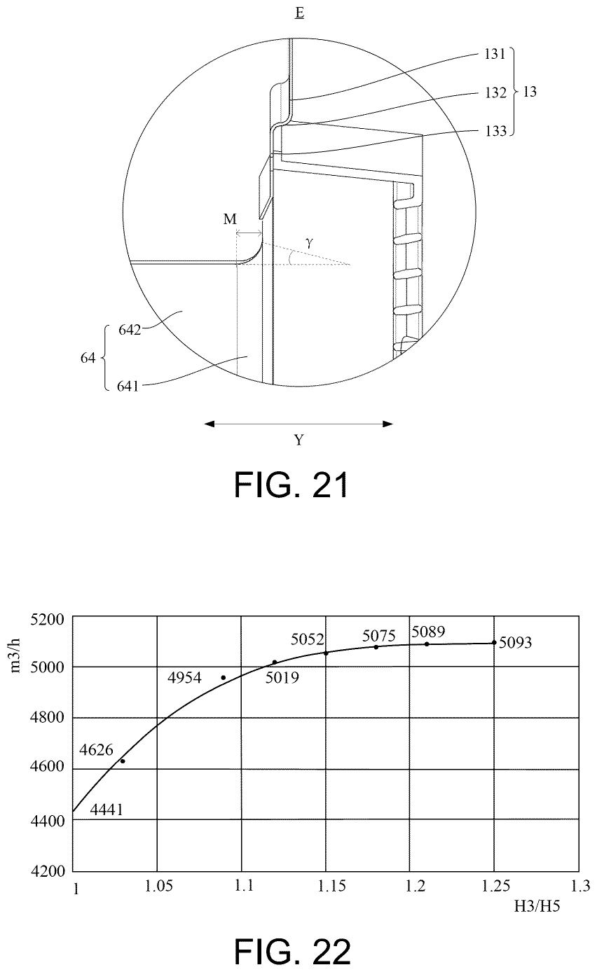

In some embodiments, as shown in FIG. 20 and FIG. 21, the air guide portion 64 includes a first sub-air guide portion 641 and a second sub-air guide portion 642, and the first sub-air guide portion 641 and the second sub-air guide portion 642 are connected. The first sub-air guide portion 641 is connected to the housing 1, the second sub-air guide portion 642 is arranged on a side of the first sub-air guide portion 641 away from the housing 1 along the Y direction, and a radial size of the first sub-air guide portion 641 decreases along a direction towards the second sub-air guide portion 642.

The first sub-air guide portion 641 of the air guide portion 64 guides the airflow blown out by the fan 2, so that the airflow can be blown towards the air outlet grille 3, the collision between the airflow and the air guide portion 64 is reduced, the resistance to the airflow is further reduced, and the air quantity of the outdoor unit 20 is increased.

In some embodiments, as shown in FIG. 21, a size of the first sub-air guide portion 641 in the axial direction of the vent 12 is defined as M, M satisfies: 0<M≤20 mm, and in this case, the airflow blown out by the fan 2 can be blown towards the air outlet grille 3 along the first sub-air guide portion 641, so that collision between the airflow and the air guide portion 64 is reduced, the resistance to the airflow is further reduced, and the air quantity of the outdoor unit 20 is increased.

It should be noted that, in the case where M>20 mm, the first sub-air guide portion 641 may excessively disperse the airflow blown by the fan 2 after the airflow is guided by the first sub-air guide portion 641. The quantity of the air blown to the positioning portion 31 of the air outlet grille 3 is increased, and the resistance of the air outlet grille 3 to the airflow and the loss of the air quantity are increased.

In some embodiments, as shown in FIG. 21, the first sub-air guide portion 641 of the air guide portion 64 includes an inner circumferential surface, which is a circumferential surface of a side of the first sub-air guide portion 641 facing the vent 12. An included angle between a normal of the inner circumferential surface and the axis of the vent 12 is defined as γ which satisfies: 75°≤γ<90°, and γ is, for example, 75°, 80°, 85° or 90°.

In this way, the first sub-air guide portion 641 can guide the airflow blown by the fan 2 to flow out of the air outlet grille 3 along the inner circumferential surface, so as to reduce the collision between the airflow and the air guide portion 64, further reduce the resistance to the airflow, and increase the air quantity of the outdoor unit 20.

It should be noted that, in the case where γ<75°, the first sub-air guide portion 641 may excessively disperse the airflow blown by the fan 2 after the airflow is guided by the first sub-air guide portion 641, so that the quantity of the air of the airflow blown to the positioning portion 31 is increased, and the resistance of the air outlet grille 3 to the airflow and the loss of the air quantity are increased.

In the case where γ=90°, the inner circumferential surface of the first sub-air guide portion 641 extends in a direction away from the accommodating cavity 11 along the axis of the vent 12, and the function of guiding the airflow to spread is lost, so that the airflow is blown onto the air guide portion 64 and collides with the air guide portion 64, and the airflow encounters the resistance from the air guide portion 64, thereby increasing the loss of the air quantity of the outdoor unit 20.

In the case where γ>90°, the radial size of the first sub-air guide portion 641 increases in a direction from the first sub-air guide portion 641 to the second sub-air guide portion 642. The inner circumferential surface of the first sub-air guide portion 641 concentrates the airflow blown out by the fan 2 towards the central axis of the vent 12, so that the inner circumferential surface of the first sub-air guide portion 641 generates the resistance to the airflow blown out by the fan 2, and the resistance to the airflow and the loss of the air quantity are increased.

In some embodiments, the minimum radial size of the second sub-air guide portion 642 is the minimum radial size of the air guide portion 64.

In some embodiments, as shown in FIG. 21, the housing 1 includes a panel 13. The panel 13 includes a first plate 131, a second plate 132, and a third plate 133, and the first plate 131, the second plate 132, and the third plate 133 are sequentially connected along the radial direction of the vent 12.

The first plate 131 is arranged around the second plate 132. The second plate 132 is arranged around the third plate 133. The third plate 133 is arranged on a side of the first plate 131 towards the accommodating cavity 11, and the vent 12 is arranged on the third plate 133. Thus, when the air outlet grille 3 is mounted to the vent 12, the size of the outdoor unit 20 in the axial direction of the vent 12 is smaller than a sum of the sizes of the positioning portion 31 and the housing 1 in the axial direction of the vent 12, which meets a requirement of a small-sized design of the outdoor unit 20.

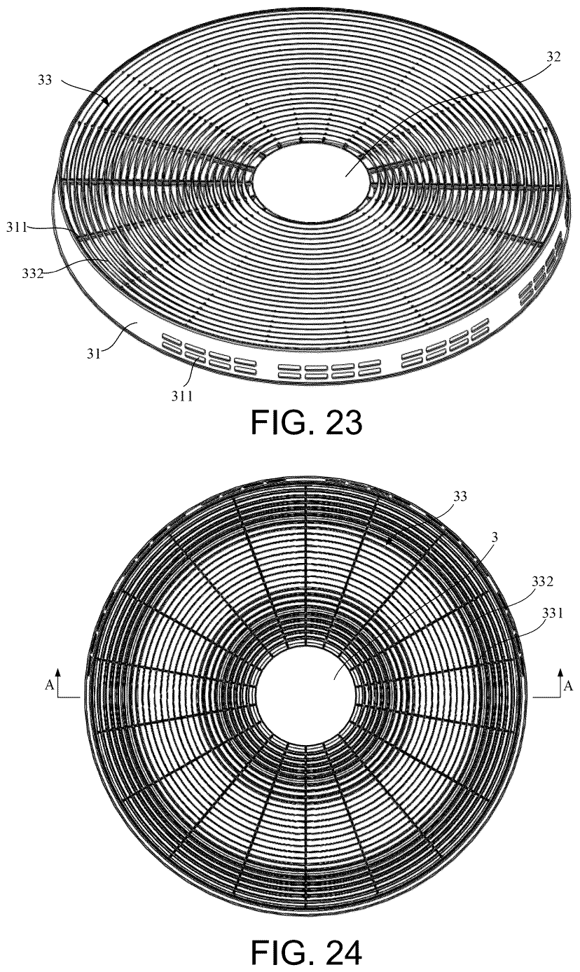

In some embodiments, the grille mesh 33 includes a plurality of grille bar layers, and the plurality of grille bar layers are arranged at intervals along the axial direction of the air outlet grille 3. For example, as shown in FIG. 23 to FIG. 25, the grille mesh 33 includes two grille bar layers, and the two grille bar layers are spaced apart in the axial direction of the air outlet grille 3.

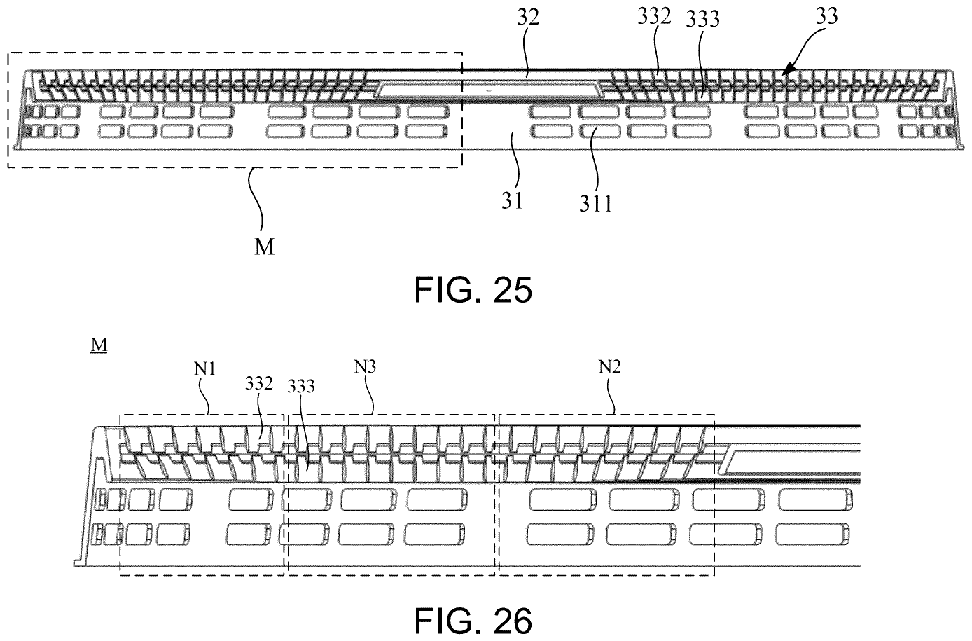

In some embodiments, as shown in FIG. 25 and FIG. 26, the grille mesh 33 further includes at least one second grille bar 333, and the at least one second grille bar 333 is arranged between the positioning portion 31 and the supporting portion 32 and located on a side of the at least one first grille bar 332 close to the fan 2. The at least one second grille bar 333 extends from a side close to the supporting portion 32 in the radial direction of the air outlet grille 3. In the case where the at least one second grille bar 333 includes a plurality of second grille bars 333, the plurality of second grille bars 333 are arranged at intervals in the radial direction of the air outlet grille 3. The plurality of second grille bars 333 are cross-connected to at least part of the at least one connecting portion 331 to form a grille bar layer of the grille mesh 33 close to the fan 2.

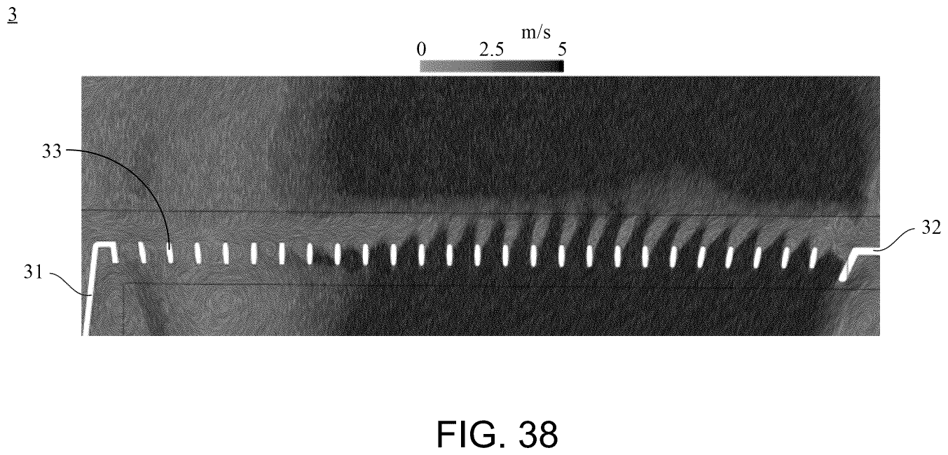

Thus, as shown in FIG. 38, the air outlet grille 3 can maintain the air resistance at the positioning portion 31 or reduce the air resistance, and can also reduce an area of a low-speed vortex region at an air outlet side of the grille mesh 33 (for example, an air outlet side of the grille mesh 33 in the multiple grille meshes 33 away from the accommodating cavity), so as to facilitate the airflow to pass through the air outlet grille 3, which reduces the air resistance and the aerodynamic noise at the air outlet grille 3, and improves an air outlet efficiency of the outdoor unit 20.

In some embodiments, the at least one connecting portion 331 is arranged between the at least one first grille bar 332 and the at least one second grille bar 333, so that the at least one connecting portion 331 can support and connect the at least one first grille bar 332 and the at least one second grille bar 333 to form the grille mesh 33 of a double-layer structure. In this way, the at least one connecting portion 331 serves as a supporting framework of the grille mesh 33 of a double-layer structure, so that the grille mesh 33 has a simple structure, and manufacturing materials can be saved.

A first direction is defined from a side of the at least one first grille bar 332 close to the at least one second grille bar 333 to a side thereof away from the at least one second grille bar 333. A second direction is defined from a side of the at least one second grille bar 333 close to the at least one first grille bar 332 to a side thereof away from the at least one first grille bar 332.

In some embodiments, in the radial direction of the positioning portion 31, at least part of the at least one first grille bar 332 extends obliquely towards the positioning portion 31 in the first direction, and at least part of the at least one second grille bar 333 extends obliquely away from the positioning portion 31 in the second direction. In this way, the resistance to the airflow passing through the grille mesh 33 can be reduced, and the air outlet efficiency of the outdoor unit can be improved.

In some embodiments, the at least one first grille bar 332 and the at least one second grille bar 333 are arranged correspondingly along an air outlet direction of the outdoor unit 20. Air outlet gaps formed between adjacent first grille bars 332 of the at least one first grille bar 332 and air outlet gaps formed between adjacent second grille bars 333 of the at least one second grille bar 333 are correspondingly arranged along the air outlet direction of the outdoor unit 20.

In some embodiments, as shown in FIG. 25 and FIG. 26, in the radial direction of the air outlet grille 3, a region close to the positioning portion 31 is defined as a first region N1, a region away from the positioning portion 31 is defined as a second region N2, and a region between the first region N1 and the second region N2 is defined as a third region N3. Each of the first region N1, the second region N2 and the third region N3 is provided with part of the at least one first grille bar 332 and part of the at least one second grille bar 333.

In some embodiments, as shown in FIG. 26, in the radial direction of the positioning portion 31, the at least one first grille bar 332 arranged in the first region N1 is arranged at intervals, and the side thereof close to the at least one second grille bar 333 extends obliquely towards the positioning portion 31; the at least one second grille bar 333 arranged in the first region N1 is arranged at intervals, and the side thereof close to the at least one first grille bar 332 extends obliquely away from the positioning portion 31.

In some embodiments, as shown in FIG. 26, in the radial direction of the positioning portion 31, the at least one first grille bar 332 and the at least one second grille bar 333 which are arranged in the third region N3 are perpendicular to a plane where the positioning portion 31 is located.

In some embodiments, as shown in FIG. 26, in the radial direction of the positioning portion 31, the side of the at least one first grille bar 332 arranged in the second region N2 away from the at least one second grille bar 333 extends obliquely away from the positioning portion 31, and the side of the at least one second grille bar 333 arranged in the second region N2 close to the at least one first grille bar 332 extends obliquely close to the positioning portion 31.

It should be noted that different first grille bars 332 and different second grille bars 333 have different deflection angles relative to the axis of the positioning portion 31.

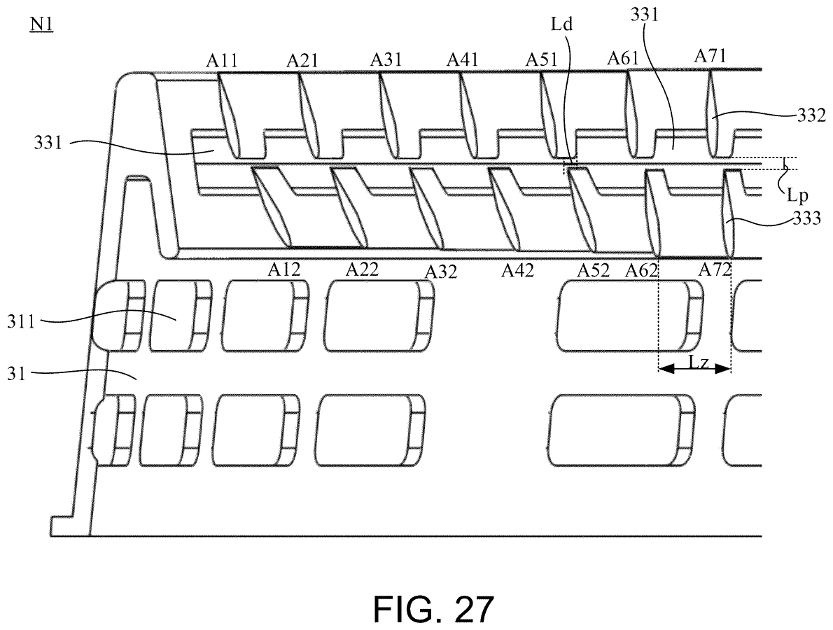

In some embodiments, as shown in FIG. 27, 7 first grille bars 332 and 7 second grille bars 333 are arranged in the first region N1.

The first grille bar 332 in the first region N1 is defined as Ai1; the second grille bar 333 in the first region N1 is defined as Ai2.

An end of the at least one first grille bar 332 in the first region N1 close to the second grille bar 333 extends towards the supporting portion 32. An included angle between the axial direction of the positioning portion 31 and a connection line between an end of the at least one first grille bar 332 in the first region N1 away from the at least one second grille bar 333 and the end of the at least one first grille bar 332 close to the at least one second grille bar 333 is defined as a first included angle θ1. An included angle between the axis of the positioning portion 31 and a connection line between an end of the at least one second grille bar 333 in the first region N1 close to the at least one first grille bar 332 and an end of the at least one second grille bar 333 away from the at least one first grille bar 332 is defined as a second included angle θ2.

During the change of i from i=1 to i=7, a distance between the at least one first grille bar 332 and the supporting portion 32 decreases, and the first included angle θ1 decreases; a distance between the at least one second grille bar 333 and the supporting portion 32 decreases, and the second included angle θ2 decreases.

In some embodiments, the second included angle of a second grille bar A12 is, for example, any value of (0°, 30°], and the second included angle is, for example, any value of [10°, 30°]. The second included angles of the other second grille bars Ai2 than the second grille bar A12 and the second included angle of the second grille bar A12 are in a linear correlation relationship. The first included angles of the other first grille bars Ai1 than a first grille bar A11 are in a linear correlation relationship with the first included angle of the first grille bar A11.

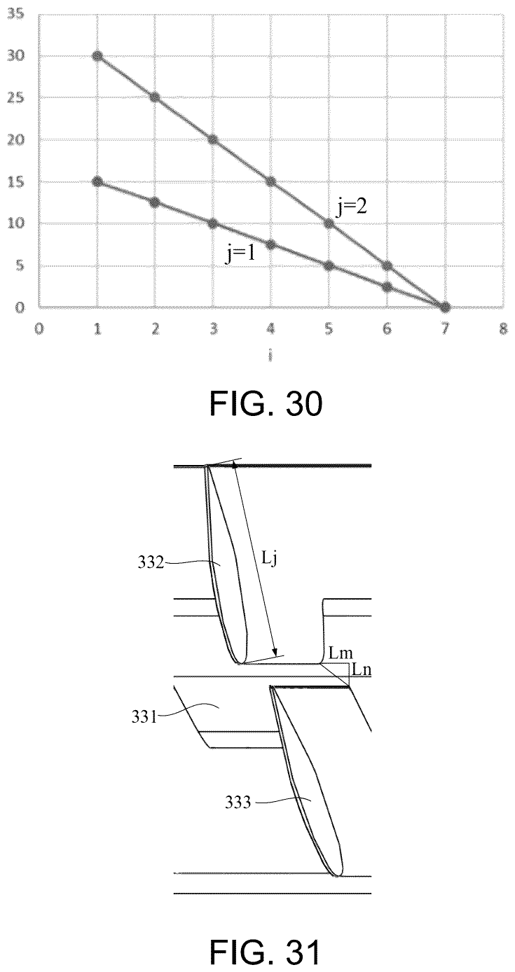

In some embodiments, as shown in FIG. 30, the second included angle θ2 of the second grille bar 333 and the first included angle θ1 of the first grille bar 332 correspondingly arranged along the air outlet direction of the outdoor unit 20 satisfy: 02=201.

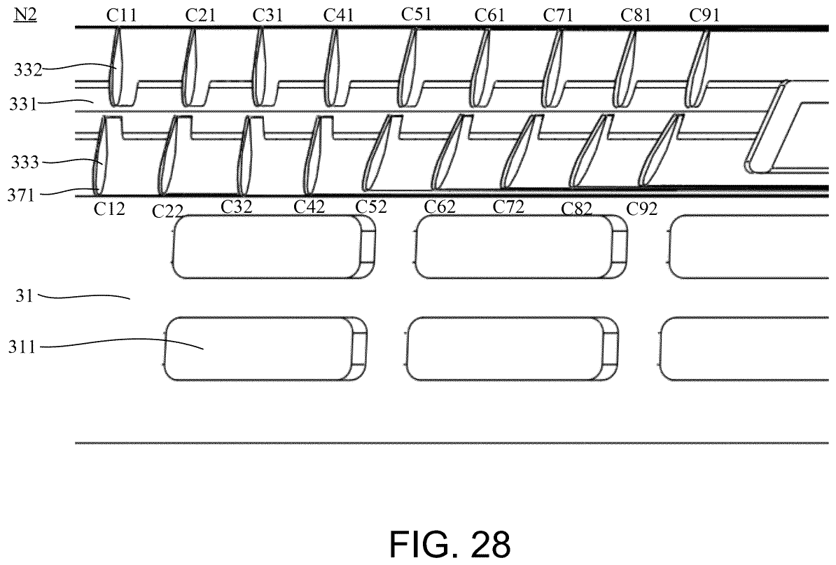

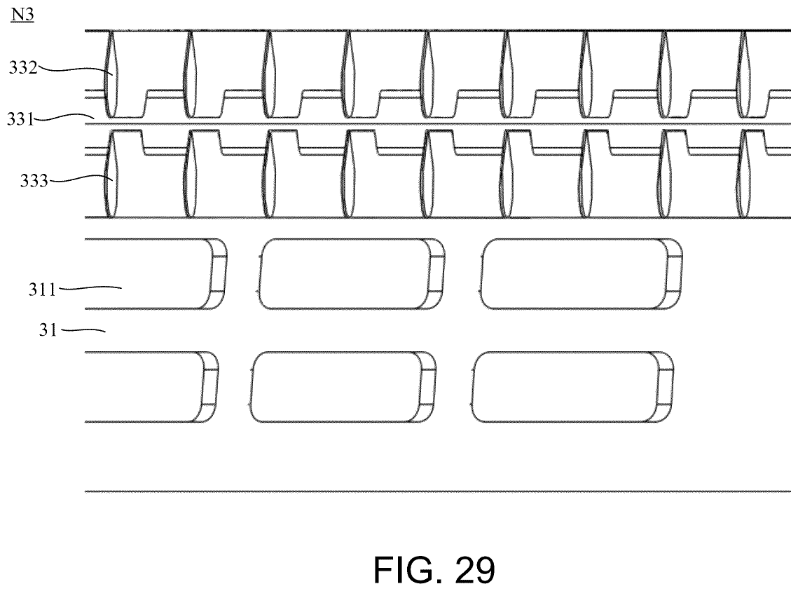

In some embodiments, as shown in FIG. 28, 9 first grille bars 332 and 9 second grille bars 333 are arranged in the third region N3, and the 9 first grille bars 332 and the 9 second grille bars 333 are perpendicular to the plane where the positioning portion 31 is located.

In some embodiments, as shown in FIG. 29, 9 first grille bars 332 and 9 second grille bars 333 are arranged in the second region N2.

The at least one first grille bar 332 in the third region N3 is defined as Ci1, and the second grille bar 333 in the third region N3 is defined as Ci2.

The at least one first grille bar 332 in the second region N2 extends from an end thereof away from the at least one second grille bar 333 towards the positioning portion 31. An included angle between the axis of the positioning portion 31 and a connection line between the end of the at least one first grille bar 332 in the second region N2 away from the at least one second grille bar 333 and an end of the at least one first grille bar 332 close to the at least one second grille bar 333 is defined as a third included angle θ3. An included angle between the axis of the positioning portion 31 and a connection line between an end of the at least one second grille bar 333 in the second region N2 close to the at least one first grille bar 332 and an end of the at least one second grille bar 333 away from the at least one first grille bar 332 is defined as a fourth included angle θ4.

During the change of i from i=1 to i=9, a distance between the at least one first grille bar 332 and the supporting portion 32 increases, and the third included angle increases; a distance between the at least one second grille bar 333 and the supporting portion 32 increases, and the fourth included angle increases.

In some embodiments, the fourth included angle of a second grille bar C92 is, for example, any value of (0°, 30°], for example, the fourth included angle is any value of [0°, 15°]. The fourth included angles of the other second grille bars Ci2 than the second grille bar C92 and the fourth included angle of the second grille bar C92 are in a linear correlation relationship. The third included angles of the other first grille bars Ci1 than a first grille bar C91 are in a linear correlation relationship with the third included angle of the first grille bar C91.

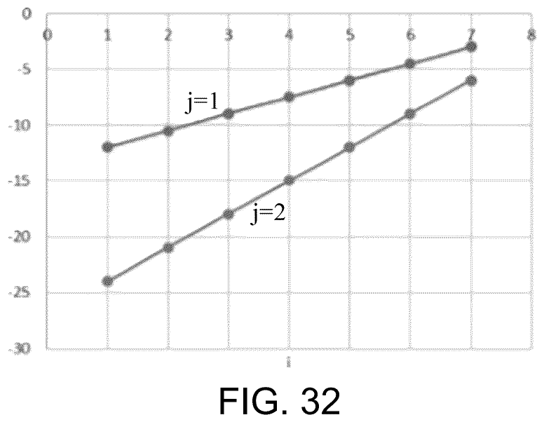

In some embodiments, as shown in FIG. 32, the fourth included angle θ4 of the at least one second grille bar 333 and the third included angle θ3 of the at least one first grille bar 332 correspondingly arranged along the air outlet direction of the outdoor unit 20 satisfy: θ4-2θ3.

In some other embodiments, along the radial direction of the air outlet grille 3, sizes of sides of the at least one first grille bar 332 and the at least one second grille bar 333 near the air outlet side increase from the air outlet side to an air inlet side. In this way, the airflow can flow alongside side walls of the at least one first grille bar 332 and the at least one second grille bar 333, thus increasing the flow speed of the airflow.

In still other embodiments, the ratio of the corresponding first included angle θ1 to second included angle θ2 in the axial direction of the positioning portion 31 falls within, for example, a range of [0.4, 0.6]. For example, the ratio between the first included angle and the second included angle which are correspondingly set belongs to [0.4, 0.5]. For another example, the ratio between the first included angle and the second included angle which are correspondingly set belongs to [0.5, 0.6].

In still other embodiments, the ratio of the corresponding third included angle θ3 to fourth included angle θ4 in the axial direction of the positioning portion 31 falls within, for example, a range of [0.4, 0.6]. For example, the ratio between the third included angle and the fourth included angle which are correspondingly set belongs to [0.4, 0.5]. For another example, the ratio between the third included angle and the fourth included angle which are correspondingly set belongs to [0.5, 0.6].

Therefore, the airflow can conveniently flow through the gap between every two adjacent grille bars, and a flow direction of the airflow can be corrected through the grille bars, so that after the airflow flows out from the grille mesh 33, an included angle between the flow direction and the axis of the positioning portion 31 is smaller or the flow direction is parallel to the axis of the positioning portion, thus increasing an air supply distance of the outdoor unit 20, and reducing the air resistance.

It should be noted that, if the ratio between the first included angle and the second included angle that are correspondingly set is determined to be smaller than 0.4, the air resistance of the air outlet grille 3 to the airflow is large. If the ratio between the first included angle and the second included angle which are correspondingly set is determined to be larger than 0.6, the air supply distance of the air outlet grille 3 is reduced. If the ratio of the third included angle and the fourth included angle that are correspondingly set is determined to be smaller than 0.4, the air resistance of the air outlet grille 3 to the airflow is large. If the ratio between the third included angle and the fourth included angle which are correspondingly set is determined to be larger than 0.6, the air supply distance of the air outlet grille 3 is reduced.

In still other embodiments, a first outer included angle β1 is equal to a first inner included angle α1. Thus, the air resistance at the grille mesh 33 can be reduced, and the air outlet quantity of the outdoor unit 20 is further increased.

In some embodiments, in the case where the positioning portion 31 has a shape of a circular ring, at least one of the plurality of first grille bars 332 arranged in the first region N1 has, for example, a concentric circular ring structure which is outward along the radial direction of the air outlet grille 3 and has an increasing radius; at least one of the plurality of second grille bars 333 arranged in the second region N2 has, for example, a concentric circular ring structure which is outward along the radial direction of the air outlet grille 3 and has a decreasing radius; at least one of the plurality of first grille bars 332 and at least one of the plurality of second grille bars 333 arranged in the third region N3 have, for example, a concentric circular ring structure which is outward along the radial direction of the air outlet grille 3 and has a constant radius.

In some embodiments, the plurality of first grille bars 332 may be connected to at least part of the at least one connecting portion 331 to form one grille mesh structure layer, and the plurality of second grille bars 333 may be connected to at least part of the at least one connecting portion 331 to form another grille mesh structure layer. The at least one second grille bar 333 and the at least one first grille bar 332 can separate and accelerate the airflow twice, reducing the air resistance of the airflow at the air outlet grille 3, and improving the air quantity and the air outlet efficiency of the outdoor unit 20.

In some other embodiments, as shown in FIG. 27, in the axial direction of the positioning portion, the at least one connecting portion 331 is arranged between the at least one first grille bar 332 and the at least one second grille bar 333, so that the at least one connecting portion 331 can support and connect the at least one first grille bar 332 and the at least one second grille bar 333 to form the grille mesh 33 of a double-layer structure. In this way, the at least one connecting portion 331 serves as a supporting framework of the grille mesh 33 of a double-layer structure, so that the grille mesh 33 has a simple structure, and manufacturing materials can be saved. In this case, the at least one connecting portion 331 is recessed towards the at least one second grille bar 333 relative to the at least one first grille bar 332, and is recessed towards the at least one first grille bar 332 relative to the at least one second grille bar 333. Thus, the manufacturing materials can be further saved, and the recessed at least one connecting portion 331 can be partially hidden relative to the grille bars.

In some other embodiments, sides of at least part of the at least one connecting portion 331 close to the first grille bars 332 are recessed towards the second grille bars 333 relative to the first grille bars 332, and sides of these connecting portions 331 close to the second grille bars 333 and sides of the second grille bars 333 away from the first grille bars 332 may be flush with each other in the axial direction of the positioning portion 31, so that the connecting portions 331 can support and connect one sides of the first grille bars 332 and the second grille bars 333, and therefore, the grille mesh 33 has a simple structure and a good appearance.

In some other embodiments, the sides of at least part of the at least one connecting portion 331 close to the first grille bars 332 are flush with sides of the first grille bars 332 away from the second grille bars 333 in the axial direction of the positioning portion 31, and the sides of these connecting portions 331 close to the second grille bars 333 may be flush with the sides of the second grille bars 333 away from the first grille bars 332 in the axial direction of the positioning portion 31, which makes the structure of the grille mesh 33 simple.

In some embodiments, as shown in FIG. 31, widths of the at least one first grille bar 332 and the at least one second grille bar 333 are defined as Lj, and in this case, maximum chord lengths of the at least one first grille bar and the at least one second grille bar 333 are Lj. Lj is, for example, any value of [4 mm, 10 mm]. For example, Lj is 4 mm, 6 mm, 7 mm, 8 mm, 9 mm, or 10 mm.

In this way, a safety performance of the air outlet grille 3 can be guaranteed, and the air resistance is lower.

It should be noted that, under the condition that Lj is smaller than 4 mm, bending strength of the at least one first grille bar 332 is low, which may cause extrusion deformation between the adjacent first grille bars 332, increasing a gap width, and reducing the safety performance of the air outlet grille 3. Under the condition that Lj is larger than 10 mm, a time for the airflow to flow through the air outlet grille 3 is increased, and air outlet resistance is increased.

In some embodiments, Lj decreases in a direction away from the positioning portion 31. Thus, the air resistance of the grille mesh 33 on the air inlet side can be reduced, and a speed of the airflow flowing out along the side wall of the second grille bar 333 can be increased.

Among the at least one second grille bar 333 and the at least one first grille bar 332 correspondingly arranged in the air outlet direction of the outdoor unit 20, a distance between a side surface of the at least one second grille bar 333 adjacent to the at least one first grille bar 332 and a side surface of the at least one first grille bar 332 adjacent to the at least one second grille bar 333 in the radial direction of the positioning portion 31 is defined as Lm, and a distance therebetween in the axial direction of the positioning portion 31 is defined as Ln.

In the first region N1 and the second region N2, Lm and Ln decrease in the direction away from the positioning portion 31.

In the third region N3, Lm=0, and Ln decreases in the direction away from the positioning portion 31.

In some embodiments, Ln and Lj satisfy: Ln=X3×Lj, where X3 ranges from 0.05 to 0.15, and Lm and Lj satisfy: Lm=X4×Lj, where X4 ranges from 0.02 to 0.2.

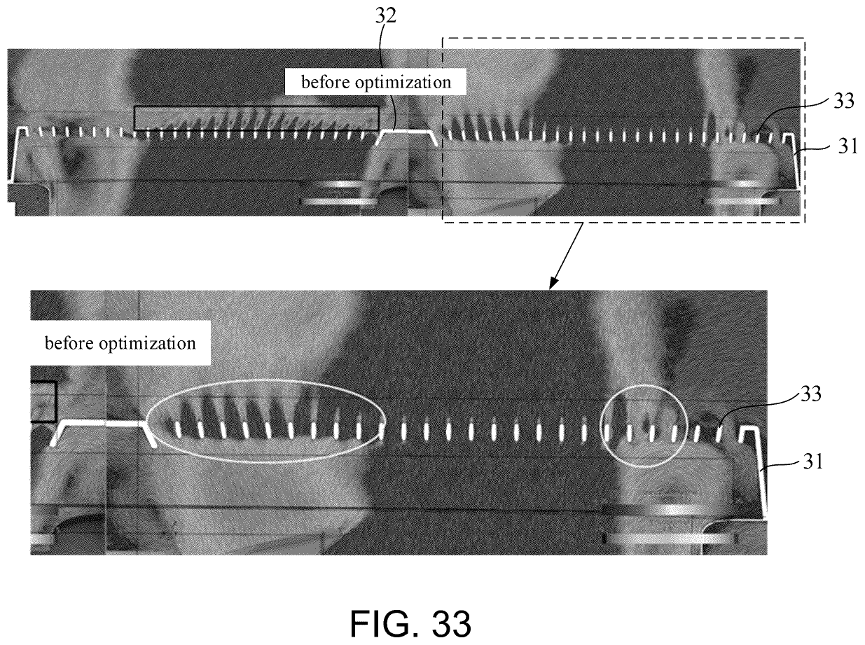

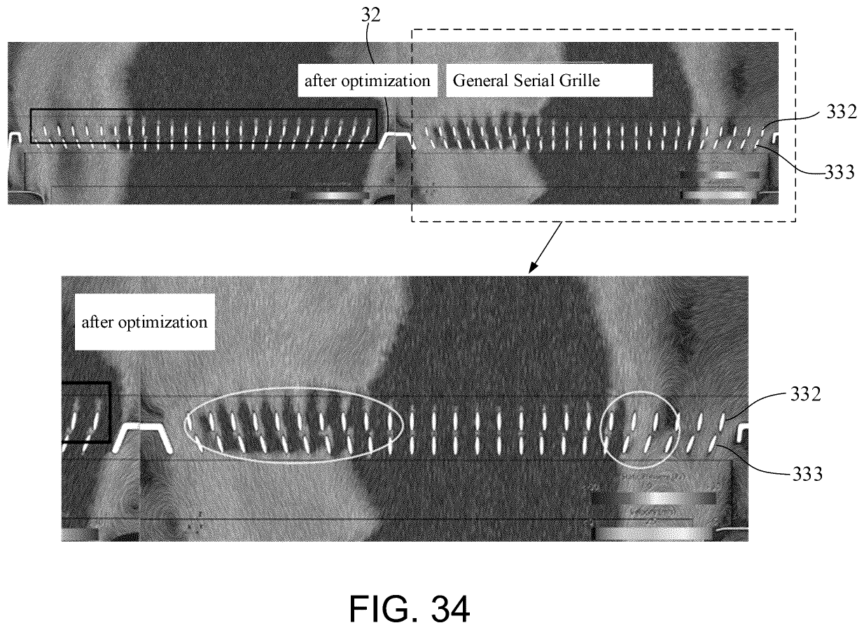

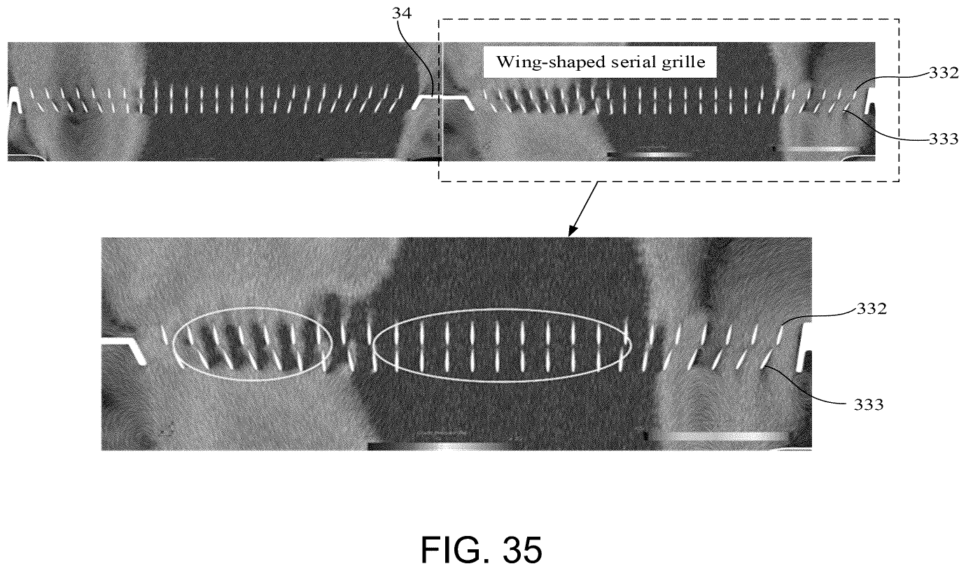

In some embodiments, as shown in FIG. 33 to FIG. 35, the definition of the first grille bar 332 and the second grille bar 333 of the air outlet grille 3 in the above embodiment may further improve the flow separation of the airflow at the air outlet grille 3, reduce the resistance of the grille bars to the airflow, improve the noise, convert kinetic energy at an air outlet of the outdoor unit 20 into pressure potential energy, and increase an air outlet distance.

In some embodiments, as shown in FIG. 27, the at least one first grille bar 332 corresponds to the at least one second grille bar 333, and in the radial direction of the air outlet grille 3, a size between sides of every two adjacent second grille bars 333 in the at least one second grille bar 333 away from the at least one first grille bar 332 is a third radial size Lz.

In some embodiments, in the radial direction of the air outlet grille 3, a size between sides of every two adjacent first grille bars 332 in the at least one first grille bar 332 close to the at least one second grille bar 333 is also the third radial size Lz.

For example, in a region between the supporting portion 32 and the positioning portion 31, N first grille bars 332 and N second grille bars 333 are provided, and in this case, the third radial size Lz is equal to (d2−d1)/N.

In some embodiments, the third radial size Lz has a range of [8.5 mm, 9.5 mm]. For example, the third radial size Lz may be 8.5 mm, 9 mm, or 9.5 mm. In this way, the grille mesh 33 can prevent foreign matter from entering the accommodating cavity 11.

In some embodiments, as shown in FIG. 27, in the axial direction of the air outlet grille 3, a size between sides of the corresponding at least one first grille bar 332 and at least one second grille bar 333 that are close to each other is defined as Lp, and a ratio of Lp to Lz falls within a range of [0.1, 0.2]. The size Lp can be 0.85 mm to 1.9 mm, for example, the size of Lp is 0.85 mm, 1.0 mm, 1.5 mm, or 1.9 mm. In this way, in the case where the airflow passes through the second grille bars 333 and the corresponding first grille bars 332 in sequence, the airflow is accelerated and a vortex is reduced by two times of flow separation.

It should be noted that, in the case where the ratio of the size Lp to the third radial size Lz is less than 0.1, the airflow cannot flow out and be separated through the at least one second grille bar 333. In the case where the ratio of the size Lp to the third radial size Lz is greater than 0.2, a low-speed separation region greater than a preset threshold is formed between the at least one second grille bar 333 and the at least one first grille bar 332.

In some embodiments, as shown in FIG. 27, in the axial direction of the air outlet grille 3, a size of spacing between a side of the second grille bar 333 adjacent to the first grille bar 332 and a side of the corresponding at least one first grille bar 332 adjacent to the at least one second grille bar 333 is defined as a fourth radial size Ld. The fourth radial size Ld is greater than zero, and a maximum ratio of the fourth radial size Ld to the third radial size Lz is in the range of [0.2, 0.3], so that the airflow smoothly passes through the grille mesh 33.

In the process that the airflow is separated from a wall surface of the second grille bar 333 and adheres to a wall surface of the at least one first grille bar 332, since the plurality of gaps with sizes being the fourth radial size Ld are formed between the at least one second grille bar 333 and the at least one first grille bar 332 in the axial direction of the positioning portion 31, a flow area of the airflow is reduced when the airflow passes through the gaps, the flow speed of the airflow is increased, and thus the air outlet quantity of the outdoor unit 20 is increased.

It should be noted that, in the radial direction of the air outlet grille 3, the sizes between the at least one second grille bar 333 and the at least one first grille bar 332 at different positions are partially the same as the fourth radial size Ld.

In some embodiments, the fourth radial size between the corresponding first and second grille bar 332, 333 arranged in the first region N1 is larger than zero, and the side of the first grille bar 332 close to the second grille bar 333 is arranged on the side of the second grille bar 333 close to the first grille bar 332 and is close to one side of the supporting portion 32 in the radial direction of the positioning portion 31. In this way, it is convenient to direct the flow direction of the airflow to be approximately parallel to the axis. For example, if the first included angle of the first grille bar 332 is increased, the corresponding fourth radial size Ld is increased, and the corresponding size is increased accordingly.

Correspondingly, the fourth radial size between the corresponding first and second grille bars 332, 333 arranged in the second region N2 is larger than zero, and the side of the first grille bar 332 close to the second grille bar 333 is arranged on the side of the second grille bar 333 close to the first grille bar 332 and is close to one side of the positioning portion 31 in the radial direction of the positioning portion 31. In this way, it is convenient to direct the flow direction of the airflow to be approximately parallel to the axis. For example, if the second included angle of the first grille bar 332 is increased, the corresponding fourth radial size Ld is increased, and the corresponding size is increased accordingly.

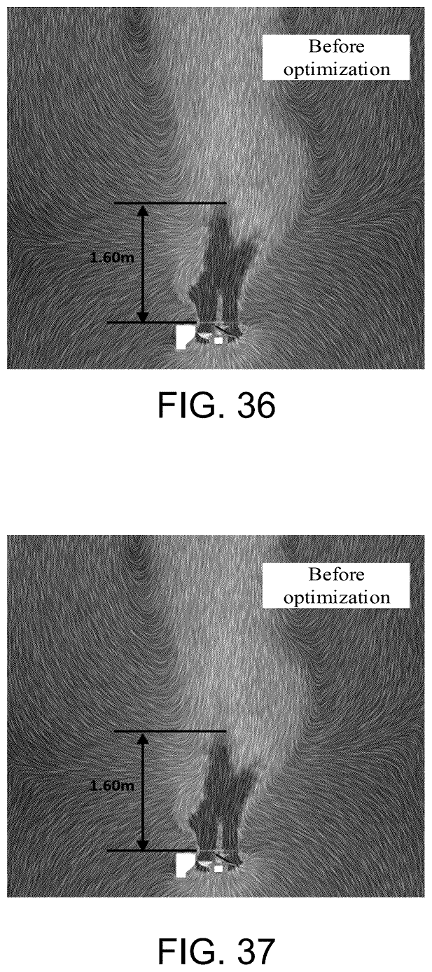

In some embodiments, as shown in FIG. 36 to FIG. 37, by taking a fan with an air supply parameter greater than or equal to 3 m/s as a high-speed air region and adopting the air outlet grille 3 optimized in some embodiments of the present disclosure, a blowing distance of the airflow by the outdoor unit 20 is 1.91 m, and by adopting the air outlet grille 3 before optimization, the blowing distance of the airflow by the outdoor unit 20 is 1.60 m, and thus, the air supply distance after optimization can be increased by 19.4% compared with the outdoor unit 20 before optimization.

TABLE 2

| | | | Air outlet | Air outlet |
|---|---|---|---|---|
| | Working | Before | grille in | grille in |
| Parameter | condition | optimization | related art | present disclosure |
| Rotating | | 720 | 720 | 720 |
| speed/rpm | | | | |
| Noise/dB | Cooling | 54 | 53 | 52 |
| Air quantity/ | Cooling | 4578 | 4650 | 4708 |
| CMH | | | | |
| Grille | Cooling | 11 | 10 | 7.5 |
| resistance/Pa | | | | |

Table 2 is a table comparing parameters and performance parameters of the outdoor unit before and after optimization in some embodiments. As shown in table 2, the resistance of the optimized air outlet grille 3 to the airflow is, for example, 7.5 Pa, and the resistance of the air outlet grille before optimization to the airflow is, for example, 11 Pa, which indicates that the resistance of the optimized air outlet grille to the airflow is reduced by 32% compared to the resistance of the air outlet grille before optimization. The noise generated by the optimized air outlet grille 3 is 52 dB, for example, and the noise generated by the air outlet grille before optimization is 54 dB, for example, which indicates that the noise generated by the optimized air outlet grille is reduced by 2 dB compared with the noise generated by the air outlet grille before optimization. Compared with the air outlet grille in the related art, the optimized air outlet grille has the advantages that the resistance to the airflow is reduced by 25%, and the generated noise is reduced by 1 dB.

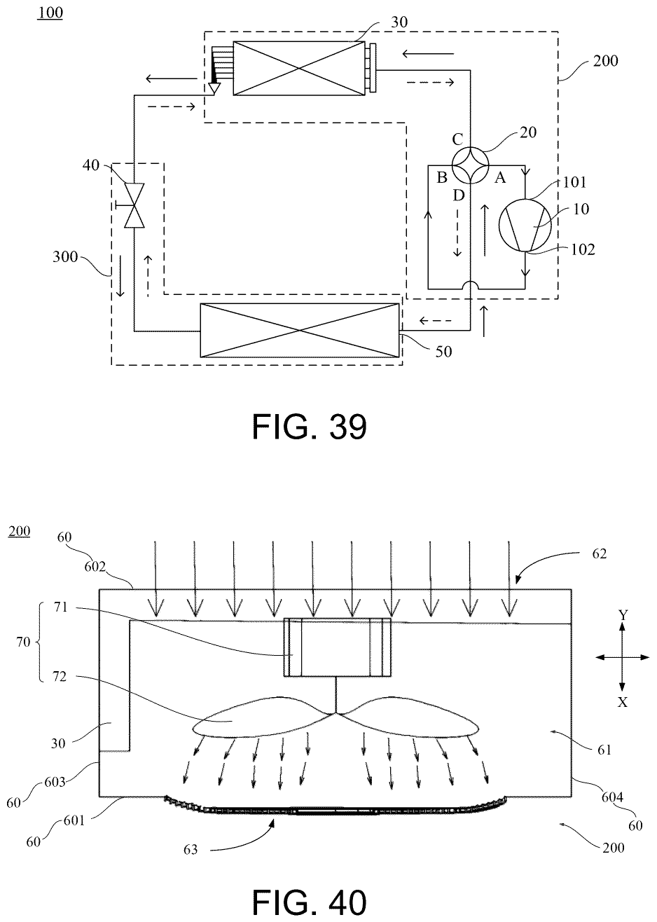

In some embodiments, as shown in FIG. 39, the air conditioner 100 further includes a compressor 10, and the compressor 10 is arranged in the outdoor unit 200, for example. The compressor 10 includes a suction port 101 and an exhaust port 102, and is configured to suck a low-temperature and low-pressure gas-phase refrigerant from the suction port 101, compress the gas-phase refrigerant in the low-temperature and low-pressure state by a motor running and driving a piston, and then discharge a high-temperature and high-pressure gas-phase refrigerant through the exhaust port 102, so that the compressor 10 can provide power for a cooling cycle.

In some embodiments, the air conditioner 100 further includes an indoor heat exchanger 50, and the indoor heat exchanger 50 is arranged in an indoor unit 300, for example.

In some embodiments, the air conditioner 100 further includes an outdoor heat exchanger 30, and the outdoor heat exchanger 30 is arranged in the outdoor unit 200, for example.

In some embodiments, the air conditioner 100 further includes a four-way valve 21, and the four-way valve 21 is arranged in the outdoor unit 200, for example. The four-way valve 21 includes a first port A, a second port B, a third port C, and a fourth port D. The first port A of the four-way valve 21 is communicated with the suction port 101 of the compressor 10, the second port B is communicated with the exhaust port 102 of the compressor 10, the third port C is communicated with the outdoor heat exchanger 30, and the fourth port D is communicated with the indoor heat exchanger 50.

In some embodiments, the air conditioner 100 further includes a pressure reducer 40. The pressure reducer 40 is arranged between the indoor heat exchanger 50 and the outdoor heat exchanger 30, and configured to reduce a pressure of a high-pressure gas-phase refrigerant in a refrigerant pipe to form a low-pressure gas-phase refrigerant and maintain a stable pressure and a stable flow rate of the output gas-phase refrigerant, so as to ensure stable operation of the air conditioner 100.

In some embodiments, as shown in FIG. 40, the outdoor unit 200 includes a casing 60. The casing 60 defines a mounting cavity 61, and the outdoor heat exchanger 30 is arranged in the mounting cavity 61.

In some embodiments, the casing 60 includes at least one air inlet 62, and the at least one air inlet 62 communicates the mounting cavity 61 with an external environment. The outdoor heat exchanger 30 is arranged adjacent to the at least one air inlet 62.

In some embodiments, the casing 60 further includes an air outlet 63, and the air outlet 63 communicates the mounting cavity 61 with the external environment.

In some embodiments, the air conditioner 100 further includes a fan 70, and the fan 70 is arranged in the mounting cavity 61 of the outdoor unit 200 and near the air outlet 63, for example. The fan 70 includes a motor 71 and a fan blade 72. The fan blade 72 is connected, for example, to an output portion of the motor 71, so that the motor 71 drives the fan blade 72 to rotate. The fan 70 is, for example, an axial flow fan.

The airflow enters the mounting cavity 61 through the air inlet 62, and after exchanging heat with the refrigerant transported in the outdoor heat exchanger 30 in the mounting cavity 61 under driving of the fan 70, the airflow flows out of the outdoor unit 200 through the air outlet 62. In this case, a negative pressure region is formed inside the mounting cavity 61, and air outside the casing 60 can flow into the mounting cavity 61 through the air inlet 62, thereby forming a heat exchange cycle of the outdoor unit 200.

In some embodiments, as shown in FIG. 40, the casing 60 further includes a first plate 601, a second plate 602, a third plate 603, and a fourth plate 604. In the case where the air outlet 63 is arranged on the first plate 601 of the casing 60, the at least one air inlet 62 may be arranged on at least one of the second plate 602, the third plate 603, or the fourth plate 604. In this case, an axis of the fan 70 is, for example, parallel to a first direction (e.g., front-rear direction of the casing 60) or a second direction (e.g., left-right direction of the casing 60).

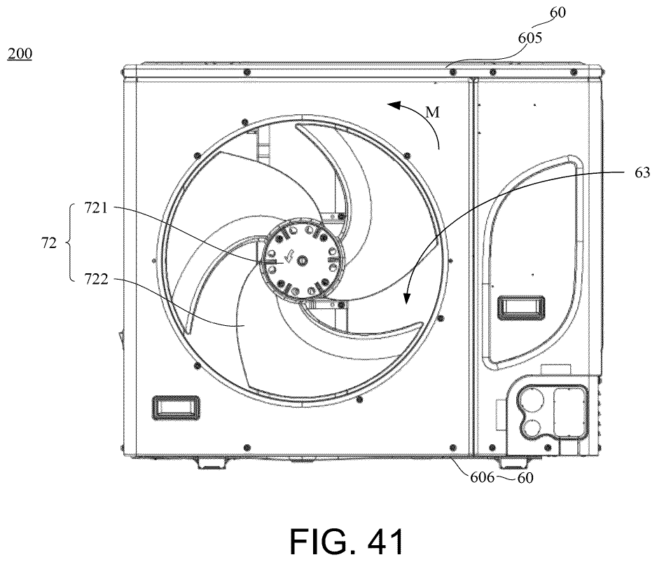

In some embodiments, as shown in FIG. 41, the casing 60 further includes a fifth plate 605 and a sixth plate 606. The fifth plate 605 is arranged corresponding to the sixth plate 606, and is connected to the first plate 601, the second plate 602, the third plate 603, and the fourth plate 604. In the case where the air outlet 63 is arranged on the fifth plate 605, the at least one air inlet 62 may be arranged on at least one of the first plate 601, the second plate 602, the third plate 603, or the fourth plate 604. In this case, the axis of the fan 70 is, for example, parallel to a third direction (e.g., up-down direction of the casing 60).

In some embodiments, as shown in FIG. 41, the fan blade 72 includes a fixed portion 721, and the fan blade 72 is connected to the output portion of the motor 71 through the fixed portion 721.

In some embodiments, as shown in FIG. 41, the fan blade 72 further includes at least one blade 722, and the at least one blade 722 is connected to the fixed portion 721. In the case where the at least one blade 722 includes a plurality of blades 722, the plurality of blades 722 are arranged at intervals in a circumferential direction of the fixed portion 721.

In some embodiments, assuming that the at least one blade 722 includes n blades 722, n being a natural number greater than or equal to 2, the n blades 722 may be spaced apart by a central angle of 360°/n in the circumferential direction of the fixed portion 721, so that stability of the fan blade 72 during rotation may be ensured. For example, in the case where the at least one blade 722 includes two blades 722, the two blades 722 may be spaced apart by a central angle of 180° in the circumferential direction of the fixed portion 721. For another example, in the case where the at least one blade 722 includes three blades 722, the three blades 722 may be spaced apart by a central angle of 120° in the circumferential direction of the fixed portion 721. For another example, in the case where the at least one blade 722 includes four blades 722, the four blades 722 may be spaced apart by a central angle of 90° in the circumferential direction of the fixed portion 721.

In some embodiments, a side of the fan blade 72 away from the motor 71 is defined as a front side (X direction in FIG. 40), and a side close to the motor 71 is defined as a rear side (Y direction in FIG. 40). In the case where the fan blade 72 rotates counterclockwise (M direction in FIG. 41), since the fan 70 delivers the airflow from the side of the fan blade 72 close to the motor 71 to the side thereof away from the motor 71, a high-pressure airflow region is formed at the side of the blade 722 of the fan blade 72 away from the motor 71, and a low-pressure region is formed at the side of the blade 722 of the fan blade 72 close to the motor 71.

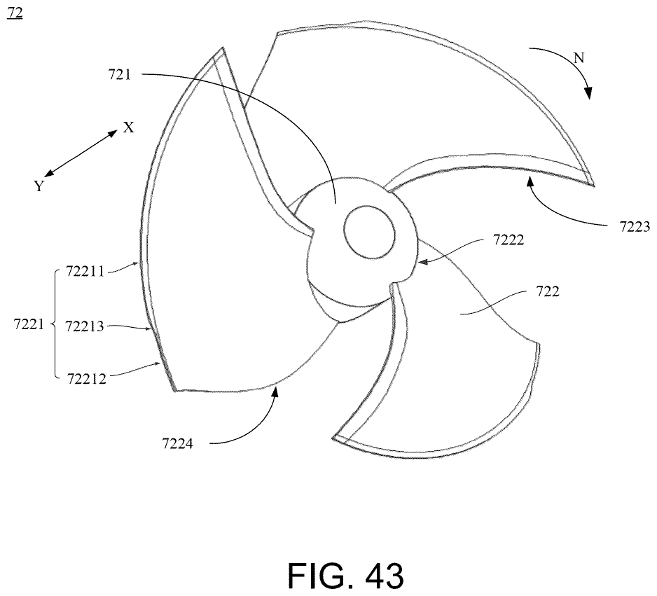

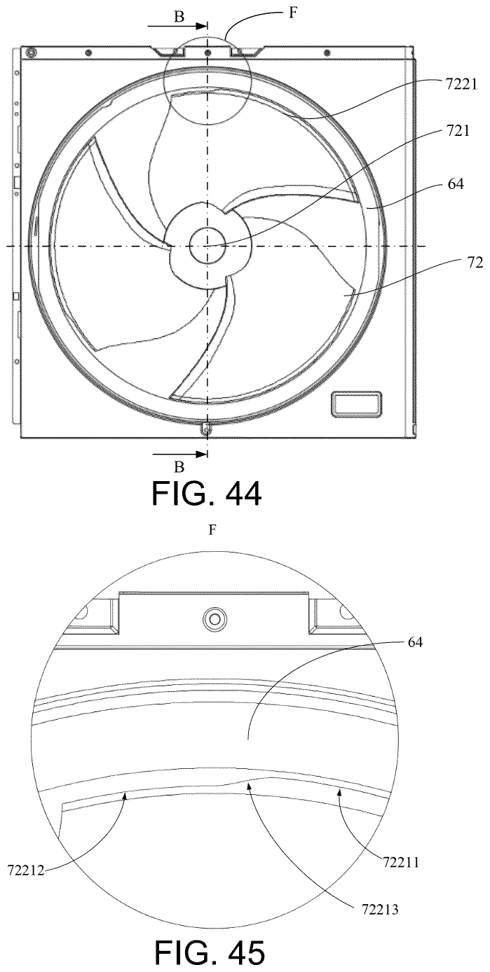

In some embodiments, as shown in FIG. 43 to FIG. 45, the at least one blade 722 includes a first edge portion 7221, the first edge portion 7221 being arranged on a side of the at least one blade 722 away from the fixed portion 721. A distance between an end of the first edge portion 7221 close to a windward side of the at least one blade 722 and an axis of the fixed portion 721 is greater than a distance between an end of the first edge portion 7221 close to a leeward side of the at least one blade 722 and the axis of the fixed portion 721.

In some embodiments, the at least one blade 722 further includes a second edge portion 7222. The second edge portion 7222 is arranged on a side of the at least one blade 722 close to the fixed portion 721, and the at least one blade 722 is connected to the fixed portion 721 via the second edge portion 7222.

In some embodiments, the at least one blade 722 further includes a third edge portion 7223. The third edge portion 7223 is arranged between the first edge portion 7221 and the second edge portion 7222, and the third edge portion 7223 is arranged on the windward side of the at least one blade 722. That is, in the case where the fan blade 72 rotates clockwise (N direction in FIG. 43), between the first edge portion 7221 and the second edge portion 7222, a side of the at least one blade 722 facing the windward side is the third edge portion 7223. The windward side of the at least one blade 722 is, for example, a side thereof facing the at least one air inlet 62.

In some embodiments, the at least one blade 722 further includes a fourth edge portion 7224. The fourth edge portion 7224 is arranged between the first edge portion 7221 and the second edge portion 7222, and the fourth edge portion 7224 is arranged on the leeward side of the at least one blade 722. That is, in the case where the fan blade 72 rotates clockwise, between the first edge portion 7221 and the second edge portion 7222, a side of the at least one blade 722 facing the leeward side is the fourth edge portion 7224. The leeward side of the at least one blade 722 is, for example, a side thereof facing the air outlet 63.

In some other embodiments, along a circumferential direction of the fan blade 72, a side of the at least one blade 722 facing a rotation direction thereof is the windward side thereof, and a side of the at least one blade 722 away from the rotation direction thereof is the leeward side thereof.

In some embodiments, as shown in FIG. 43 and FIG. 48, a radial distance between an end of the first edge portion 7221 near the third edge portion 7223 and the axis of the fixed portion 721 is greater than a radial distance between an end of the first edge portion 7221 near the fourth edge portion 7224 and the fixed portion 721. In this way, a gap between the blade 722 and a frame of the air outlet 63 can be reduced, so that air leakage at the gap is reduced, an air outlet quantity of the fan 70 is increased, an air outlet efficiency of the air conditioner 100 is improved, and operation power consumption of the air conditioner 100 is reduced.

In some embodiments, by increasing a radial size of a position of the first edge portion 7221 of the blade 722 near the third edge portion 7223, the radial distance between the end of the first edge portion 7221 near the third edge portion 7223 and the axis of the fixed portion 721 can be greater than the radial distance between the end of the first edge portion 7221 near the fourth edge portion 7224 and the fixed portion 721. In this way, a contact area of the blade 722 and the airflow is also increased, which is beneficial to increasing the air outlet quantity of the air conditioner 100. It is also possible to reduce vortexes and pressure pulsation at the at least one blade 722 caused by viscous resistance formed between gas and solid at the first edge portion 7221 and the fourth edge portion 7224 and a thickness of the at least one blade 722, thus improving flocculation at a surface of the at least one blade 722 and wake on the leeward side thereof, improving an aerodynamic efficiency of the fan 70, and reducing the noise generated when the fan 70 runs.

In some embodiments, as shown in FIG. 43, the first edge portion 7221 includes a first sub-edge portion 72211, the first sub-edge portion 72211 being arranged at an end of the first edge portion 7221 close to the third edge portion 7223. The first edge portion 7221 is connected to an end of the third edge portion 7223 away from the fixed portion 721 via the first sub-edge portion 72211.

In some embodiments, the first edge portion 7221 further includes a second sub-edge portion 72212, the second sub-edge portion 72212 being arranged at an end of the first edge portion 7221 close to the fourth edge portion 7224. The first edge portion 7221 is connected to an end of the fourth edge portion 7224 away from the fixed portion 721 via the second sub-edge portion 72212.

In some embodiments, the first edge portion 7221 further includes a third sub-edge portion 72213. The third sub-edge portion 72213 is arranged between the first sub-edge portion 72211 and the second sub-edge portion 72212, and is connected to the first sub-edge portion 72211 and the second sub-edge portion 72212 respectively.

In some embodiments, compared to conventional blades, when a radial size of the first edge portion 7221 is increased, a radial size of the second sub-edge portion 72212 may be kept unchanged or reduced, or the radial size of the second sub-edge portion 72212 may be increased while a radial size of the first sub-edge portion 72211 is increased accordingly, so that a distance between the first sub-edge portion 72211 and the axis of the fixed portion 721 is greater than a distance between the second sub-edge portion 72212 and the axis of the fixed portion 721.

In some embodiments, the first sub-edge portion 72211 includes a first end, the first end being arranged on a side of the first sub-edge portion 72211 proximate to the third edge portion 7223. The first sub-edge portion 72211 is connected to an end of the third edge portion 7223 away from the fixed portion 721 by the first end.

In some embodiments, the first sub-edge portion 72211 further includes a second end, the second end being arranged on a side of the first sub-edge portion 72211 distal from the third edge portion 7223. The first sub-edge portion 72211 is connected to the third sub-edge portion 72213 by the second end.

In some embodiments, the second sub-edge portion 72212 includes a third end, the third end being arranged on a side of the second sub-edge portion 72212 proximate to the fourth edge portion 7224. The second sub-edge portion 72212 is connected to an end of the fourth edge portion 7224 away from the fixed portion 721 by the third end.

In some embodiments, the second sub-edge portion 72212 further includes a fourth end, the fourth end being arranged on a side of the second sub-edge portion 72212 distal from the fourth edge portion 7224. The second sub-edge portion 72212 is connected to the third sub-edge portion 72213 by the fourth end.

It should be noted that, by providing the third sub-edge portion 72213 between the first sub-edge portion 72211 and the second sub-edge portion 72212, contact resistance of air caused by a large abrupt change of the radial size from the first sub-edge portion 72211 to the second sub-edge portion 72212 can be reduced, and an air outlet efficiency of the fan blade 72 is improved.

In some embodiments, a plane perpendicular to an axis of the fan blade 72 is defined as a cross section thereof, then at least one of a projection of the first sub-edge portion 72211 on the cross section and a projection of the second sub-edge portion 72212 on the cross section is an arc structure.

For example, if the projection of the first sub-edge portion 72211 on the cross section is a first circular arc, and the projection of the second sub-edge portion 72212 on the cross section is a second circular arc, circle centers of the first circular arc and the second circular arc are coincident and are located at an intersection of the axis of the fan blade 72 and the cross section.

In some embodiments, a distance between the first end of the first sub-edge portion 72211 and the axis of the fixed portion 721 is the same as a distance between the second end of the first sub-edge portion 72211 and the axis of the fixed portion 721, and a distance between the third end of the second sub-edge portion 72212 and the axis of the fixed portion 721 is the same as a distance between the fourth end of the second sub-edge portion 72212 and the axis of the fixed portion 721.

For another example, the projection of the second sub-edge portion 72212 on the cross section is a second circular arc, and the projection of the first sub-edge portion 72211 on the cross section is an arc structure.

In some embodiments, a radial size of the projection of the first sub-edge portion 72211 on the cross section of the fan blade 72 increases in a direction from the second end to the first end. That is, the distance between the first end of the first sub-edge portion 72211 and the axis of the fixed portion 721 is greater than the distance between the second end and the axis of the fixed portion 721.

For another example, the projection of the second sub-edge portion 72212 on the cross section is an arc structure, and the projection of the first sub-edge portion 72211 on the cross section is a first circular arc.

In some embodiments, a radial size of the projection of the second sub-edge portion 72212 on the cross section of the fan blade 72 increases in a direction from the third end to the fourth end. That is, the distance between the third end of the second sub-edge portion 72212 and the axis of the fixed portion 721 is smaller than the distance between the fourth end and the axis of the fixed portion 721.

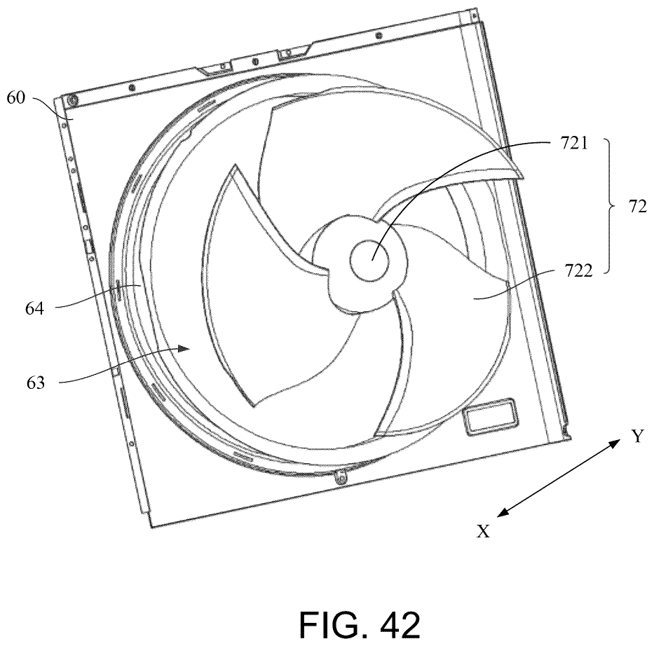

In some embodiments, as shown in FIG. 42, the casing 60 further includes an air guide portion 64, and the air guide portion 64 defines the air outlet 63.

In some embodiments, in the case of mounting the fan blade 72, as shown in FIG. 7, at least part of the fan blade 72 is arranged at the air outlet 63.

In some embodiments, a difference between a radial size of the air guide portion 64 (e.g., a radius of the air guide portion 64) and the radial size of the first sub-edge portion 72211 of the first edge portion 7221 is less than a difference between the radial size of the air guide portion 64 and the radial size of the second sub-edge portion 72212. Therefore, an effective area of the fan blade 72 can be increased, a leakage area and an air leakage amount of a gap between the at least one blade 722 and the air guide portion 64 are reduced, an air outlet quantity and an aerodynamic efficiency of the fan blade 72 are improved, and the noise generated when the fan 70 operates is reduced.

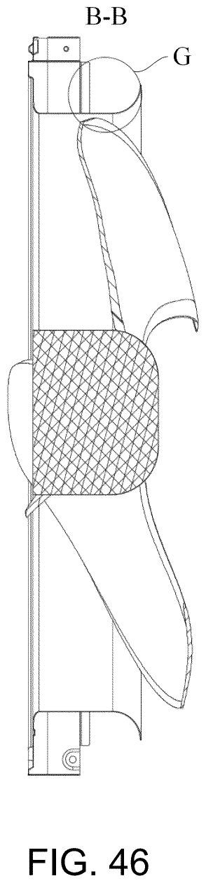

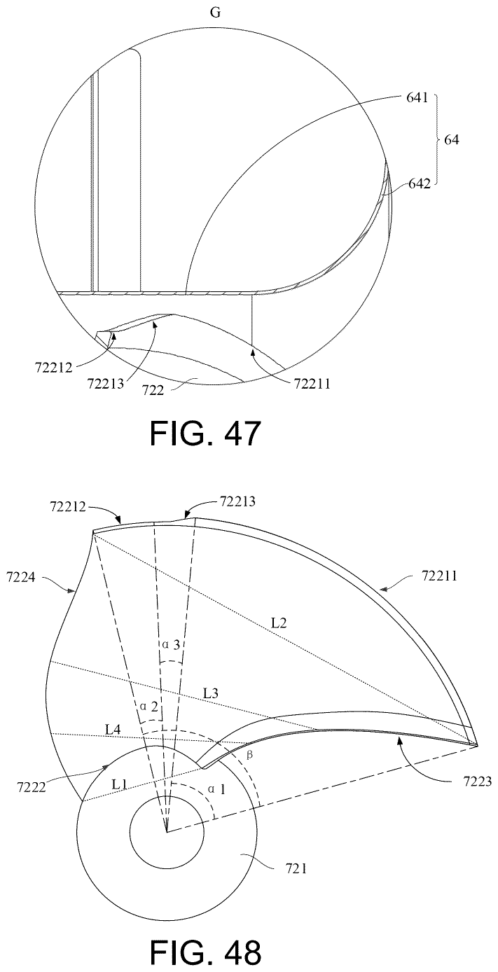

In some embodiments, as shown in FIG. 46 and FIG. 47, a first sub-air guide portion 641 is arranged around the air outlet 63 and located on a side of the air guide portion 64 away from the mounting cavity 61.

In some embodiments, a second sub-air guide portion 642 is connected to the first sub-air guide portion 641 and is located on a side of the air guide portion 64 close to the mounting cavity 61.

In some embodiments, a radial size of the second sub-air guide portion 642 increases in the direction from a side thereof close to the first sub-air guide portion 641 to a side thereof away from the first sub-air guide portion 641, so that the airflow can smoothly flow through the air outlet 63, an air inlet amount and an air outlet amount at the air outlet 63 are increased, and noise generated when the airflow flows is reduced.

In some embodiments, in an axial direction of the air guide portion 64, the second sub-edge portion 72212 is located inside the air guide portion, that is, a rear side part of the fan blade 72 is located between the air guide portion 64 and the outdoor heat exchanger 30, that is, a rear side of the fan blade 72 protrudes rearwards relative to the air guide portion 64. This is beneficial to reducing an axial size of the air guide portion 64, thereby saving manufacturing materials.

In some embodiments, as shown in FIG. 47, in an axial direction of the fan blade 72, the second sub-edge portion 72212 and the third sub-edge portion 72213 of the at least one blade 722 are arranged in the air outlet 63 defined by the first sub-air guide portion 641, for example. That is, projections of the second sub-edge portion 72212 and the third sub-edge portion 72213 along the radial direction thereof may be located on the first sub-air guide portion 641. A part of the first sub-edge portion 72211 of the at least one blade 722 close to the third edge portion 7223 is located between the air guide portion 64 and the outdoor heat exchanger 30, that is, the first sub-edge portion 72211 extends, for example, from the first sub-air guide portion 641 to the second sub-air guide portion 642 or to a region between the air guide portion 64 and the outdoor heat exchanger 30.

In some embodiments, a difference between an inner diameter of the air guide portion 64 (e.g., radius of the air guide portion 64) and a distance between the second sub-edge portion 72212 and the axis of the fixed portion 721 is, for example, any value of [6 mm, 12 mm]. For example, the difference is any value of [6 mm, 7 mm]. For another example, the difference is any value of [7 mm, 9 mm]. For another example, the difference is any value of [9 mm, 12 mm]. This facilitates the positioning and mounting of the fan blade 72 and the air guide portion 64.

In some embodiments, a difference between a distance between the first sub-edge portion 72211 and the axis of the fixed portion 721 and a distance between the second sub-edge portion 72212 and the axis of the fixed portion 721 may be any value of [2 mm, 20 mm]. For example, the difference is any value of [2 mm, 5 mm]. For another example, the difference is any value of [5 mm, 10 mm]. For another example, the difference is any value of [10 mm, 15 mm]. For another example, the difference is any value of [15 mm, 20 mm].

In some embodiments, the distance between the first sub-edge portion 72211 and the axis of the fixed portion 721 is smaller than the inner diameter of the air guide portion 64, so that a difference between the inner diameter of the air guide portion 64 and the distance between the first sub-edge portion 72211 and the axis of the fixed portion 721 can be, for example, any value of [2 mm, 4 mm]. For example, the difference is any value of [2 mm, 3 mm]. For another example, the difference is any value of [3 mm, 4 mm]. Therefore, an area of the fan blade 72 can be increased, air leakage can be reduced, and contact friction resistance between the fan blade 72 and the air guide portion 64 during rotation can be avoided.

In some embodiments, in a part of the first sub-edge portion 72211 corresponding to the first sub-air guide portion 641, the distance between the first sub-edge portion 72211 and the axis of the fixed portion 721 is smaller than an inner diameter of the first sub-air guide portion 641. For example, a difference between the inner diameter of the first sub-air guide portion 641 and the distance between the first sub-edge portion 72211 and the axis of the fixed portion 721 can be, for example, any value of [2 mm, 4 mm]. For example, the difference is any value of [2 mm, 3 mm]. For another example, the difference is any value of [3 mm, 4 mm]. Therefore, contact friction resistance between the fan blade 72 and the first sub-air guide portion 641 during rotation can be avoided.

In a part of the first sub-edge portion 72211 corresponding to the second sub-air guide portion 642, the distance between the first sub-edge portion 72211 and the axis of the fixed portion 721 is smaller than an inner diameter of the second sub-air guide portion 642. For example, a difference between the inner diameter of the second sub-air guide portion 642 and the distance between the first sub-edge portion 72211 and the axis of the fixed portion 721 can be, for example, any value of [2 mm, 4 mm]. For example, the difference is any value of [2 mm, 3 mm]. For another example, the difference is any value of [3 mm, 4 mm]. Therefore, contact friction resistance between the fan blade 72 and the second sub-air guide portion 642 during rotation can be avoided.

In some embodiments, the distance between the first sub-edge portion 72211 and the axis of the fixed portion 721 is larger than or equal to the inner diameter of the first sub-air guide portion 641. For example, in the part of the first sub-edge portion 72211 corresponding to the second sub-air guide portion 642, the distance between the first sub-edge portion 72211 and the axis of the fixed portion 721 is larger than or equal to the inner diameter of the first sub-air guide portion 641.

In some embodiments, in the case where at least part of the first sub-edge portion 72211 is located between the second sub-air guide portion 642 and the outdoor heat exchanger 30, a distance between the part of the first sub-edge portion 72211 and the axis of the fixed portion 721 is greater than or equal to a maximum radial size of the second sub-air guide portion 642.

In some embodiments, a curve of the third sub-edge portion 72213 includes, for example, at least one of a first curve y₁, a second curve y₂, or a third curve y₃.

In the case where the curve of the third sub-edge portion 72213 includes two of the first curve y₁, the second curve y₂, and the third curve y₃, the third sub-edge portion 72213 satisfies the following conditions:
along a direction from the first sub-edge portion 72211 to the second sub-edge portion 72212, the third sub-edge portion 72213 is formed by sequentially connecting the first curve y₁ and the second curve y₂, and an end of the first curve y₁ away from the second curve y₂ is connected to the first sub-edge portion 72211; or
along the direction from the first sub-edge portion 72211 to the second sub-edge portion 72212, the third sub-edge portion 72213 is formed by sequentially connecting the first curve y₁ and the third curve y₃, and an end of the first curve y₃ away from the third curve y₃ is connected to the first sub-edge portion 72211; or
along the direction from the first sub-edge portion 72211 to the second sub-edge portion 72212, the third sub-edge portion 72213 is formed by sequentially connecting the second curve y₂ and the third curve y₃, and an end of the second curve y₂ away from the third curve y₃ is connected to the first sub-edge portion 72211.

In some other embodiments, the curve of the third sub-edge portion 72213 includes the first curve y₁, the second curve y₂, and the third curve y₃. Along the direction from the first sub-edge portion 72211 to the second sub-edge portion 72212, the third sub-edge portion 72213 is formed by sequentially connecting the first curve y₁, the second curve y₂ and the third curve y₃. An end of the first curve y₁ away from the second curve y₂ is connected to the first sub-edge portion 72211, an end of the third curve y₃ away from the second curve y₂ is connected to the second sub-edge portion 72212, and the first curve y₁ is connected to the third curve y₃ through the second curve y₂.

In this way, air resistance at the third sub-edge portion 72213 can be reduced, and a reduction of overall resistance of the fan 70 during rotation is facilitated, thereby improving the air outlet efficiency of the fan 70.

In this way, the resistance generated at the third sub-edge portion 72213 during the rotation of the at least one blade 722 along an axis thereof due to a large change of the radial sizes of the first sub-edge portion 72211 and the second sub-edge portion 72212 may be reduced.

In some exemplary embodiments, a shape of the first curve is:

$${y}_{1} = - 0.0003 \times {x}_{1}^{3} + 0.0022 \times {x}_{1}^{2} + 0.025 \times {x}_{1} - 0.0 \; 017 ; wherein 0.666774 \leq {x}_{1} \leq 10.84 \; 265 ;$$

a shape of the second curve is:

$${y}_{2} = - 3 \times 1 {0}^{- 7} \times {x}_{2}^{5} + 5 \times 1 {0}^{- 5} \times {x}_{2}^{4} - 0.0034 \times {x}_{2}^{3} + 0.102 \times {x}_{2}^{2} - 1.24 \; 75 \times {x}_{2} + 5.3 \; 635 ; wherein 10.84265 \leq {x}_{2} \leq 49.906286 \; 083 ;$$

a shape of the third curve is:

$${y}_{3} = - 0.0006 \times {x}_{3}^{3} + 0.10004 \times {x}_{3}^{2} + 5.2005 \times {x}_{3} - 84.801 ; wherein 49.906286083 \leq {x}_{3} \leq 58.208570544 .$$

In some embodiments, as shown in FIG. 48, along the axial direction of the fan blade 72, a perpendicular projection of the first edge portion 7221 on the cross section of the fan blade 72 is defined as a first arc; an included angle formed by connection lines between two ends of the first arc and the axis of the fan blade 72 is defined as a first arc center angle β; an included angle at a corresponding axis of a perpendicular projection of the first sub-edge portion 72211 on the cross section of the fan blade 72 is defined as a first sub-arc center angle α1; an included angle at a corresponding axis of a perpendicular projection of the second sub-edge portion 72212 on the cross section of the fan blade 72 is defined as a second sub-arc center angle α2.

A ratio of the first sub-arc center angle α1 to the first arc center angle β is any one of [76%, 81%]. For example, the ratio of the first sub-arc center angle α1 to the first arc center angle β may be 76%, 77%, 78%, 79%, 80%, or 81%.

A ratio of the second sub-arc center angle α2 to the first arc center angle β is any one of [13%, 18%]. For example, the ratio of the second sub-arc center angle α2 to the first arc center angle β may be 13%, 14%, 15%, 16%, 17%, or 18%.

In some embodiments, an included angle at a corresponding axis of a perpendicular projection of the third sub-edge portion 72213 on the cross section of the fan blade 72 is defined as a third sub-arc center angle α3, and a ratio of the third sub-arc center angle α3 to the first arc center angle β is any value of [4%, 8%]. For example, the ratio of the third sub-arc center angle α3 to the first arc center angle β may be 4%, 5%, 6%, 7%, or 8%.

In this way, extension lengths of the first sub-edge portion 72211, the third sub-edge portion 72213, and the second sub-edge portion 72212 can be obtained.

In some embodiments, under the condition that the ratio of the first sub-arc center angle α1 to the first arc center angle β is 78.85%, the ratio of the second sub-arc center angle α2 to the first arc center angle β is 15.35%, and the ratio of the third sub-arc center angle α3 to the first arc center angle β is 5.8%, the lengths of the first sub-edge portion 72211, the third sub-edge portion 72213, and the second sub-edge portion 72212 are designed and the corresponding fan blade 72 is manufactured, so that the fan blade 72 has a good effect of increasing the air quantity and a good effect of reducing the air noise.

In some embodiments, an element chord length of the at least one blade 722 is defined as a length of a connection line between positions of the third edge portion 7223 and the fourth edge portion 7224 with the same length. In a direction from the second edge portion 7222 to the first edge portion 7221, the element chord length of the at least one blade 722 is increased and then decreased, which is beneficial to improving an air supply efficiency of the fan blade 72 and reducing air supply noise thereof.

As shown in FIG. 48, in a direction from the fixed portion 721 towards the first edge portion 7221, an element chord length of a connection line of intersections of the second edge portion 7222 with the third edge portion 7223 and the fourth edge portion 7224 is defined as a 0% element chord length L1 of the at least one blade 722; an element chord length of a connection line of intersections of the first edge portion 7221 with the third edge portion 7223 and the fourth edge portion 7224 is defined as a 100% element chord length L1 of the at least one blade 722; a connection line of positions of 50% of lengths of the third edge portion 7223 and the fourth edge portion 7224 is defined as a 50% element chord length L3 of the at least one blade 722; a connection line of positions of 25% of the lengths of the third edge portion 7223 and the fourth edge portion 7224 is defined as a 25% element chord length L4 of the at least one blade 722; a connection line of positions of 75% of the lengths of the third edge portion 7223 and the fourth edge portion 7224 is defined as a 75% element chord length L5 of the blade 722.

In some embodiments, shape and sizes of the third edge portion 7223 and the fourth edge portion 7224 of the at least one blade 722 satisfy: L3>L5>L2 and L3>L4>L1, which is beneficial to improving the air supply efficiency of the fan blade 72 and reducing the air supply noise thereof.

In some embodiments, the curve of the third edge portion 7223 of the at least one blade 722 may include a fourth curve y₄ and a fifth curve y5 which are sequentially connected to form the third edge portion 7223 along the direction from the second edge portion 7222 to the first edge portion 7221.

A shape of the fourth curve is:

$${y}_{4} = - 1 \times 1 {0}^{- 5} \times {x}_{4}^{6} + 0.02 \times {x}_{4}^{5} - 12.76 \times {x}_{4}^{4} + 4339. 4 \times {x}_{4}^{3} - 829987 \times {x}_{4}^{2} + 8 \times 1 {0}^{7} \times {x}_{4} - 4 \times 1 {0}^{9} , ( 24 \; 7.0999234 \leq {x}_{4} \leq 264.55928 \; 76 ) ;$$

a shape of the fifth curve is:

$${y}_{5} = 3 \times 1 {0}^{- 6} \times {x}_{5}^{6} - 0.004 \times {x}_{5}^{5} + 2.5565 \times {x}_{5}^{4} - 862.89 \times {x}_{5}^{3} + 163802 \times {x}_{5}^{2} - 2 \times 1 {0}^{7} \times {x}_{5} + 7 \times 1 {0}^{8} , ( 245.7355578 \leq {x}_{5} \leq 264.5592876 ) .$$

A part between the intersection of the 50% element chord length of the third edge portion 7223 and the second edge portion 7222 may be set as the curve y₄, and a part between the intersection of the 50% element chord length of the third edge portion 7223 and the first edge portion 7221 may be set as the curve y₅.

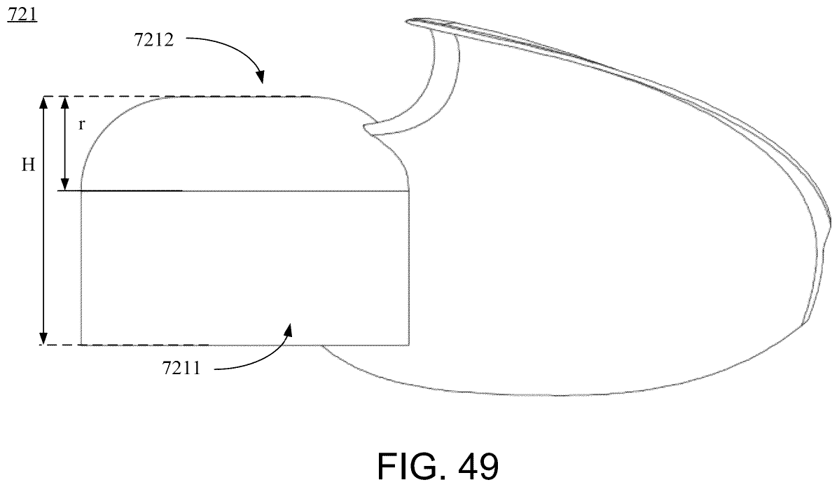

In some embodiments, as shown in FIG. 49, the fixed portion 721 further includes a first sub-fixed portion 7211, and the first sub-fixed portion 7211 is arranged near the mounting cavity 61.

In some embodiments, the fixed portion 721 further includes a second sub-fixed portion 7212, and the second sub-fixed portion 7212 is arranged away from the mounting cavity 61 and connected to the first sub-fixed portion 7211.

In some embodiments, a size of the fixed portion 721 along the axial direction of the fan blade 72 is defined as H which is, for example, 85 mm.

A maximum size of the second sub-fixed portion 7212 in the axial direction of the fan blade 72 is defined as r which is, for example, 48.87 mm.

In some embodiments, the air guide portion 64 and the casing 60 are made of metal materials, for example, iron alloy. The fan blade 72 is made of, for example, polypropylene or acrylonitrile butadiene styrene (ABS) plastic.

In some embodiments, a size of the air guide portion 64 along the axial direction thereof is set to be 120 mm, a diameter of the air guide portion 64 is set to be 620 mm, the at least one blade 722 includes three blades 722, and a diameter of the fan blade 72 is set to be 600 mm.

Before optimization, a static pressure of the fan 70 and the air guide portion 64 is 45 Pa when the rotating speed is 730 rpm, power consumption of the fan 70 is 176.5 W, and the air outlet quantity at the air outlet 63 is 5480 m³/h, that is, a static pressure efficiency of the fan 70 before optimization is 38%.

After optimization, the static pressure of the fan 70 and the air guide portion 64 is 45 Pa when the rotating speed is 730 rpm, the power consumption of the fan 70 is 165.4 W, and the air outlet quantity at the air outlet 63 is 5490 m³/h, that is, the static pressure efficiency of the fan 70 after optimization is 40%.

It can be learned from the above parameters that by optimizing the fan 70 and the air guide portion 64, the air outlet quantity of the fan 70 is increased at the same rotating speed, the air outlet efficiency is improved, the power consumption is reduced, and the air noise is reduced.

TABLE 3

| | Before optimization | | | After optimization | | |
|---|---|---|---|---|---|---|
| | Air | Power | Noise | Air | Power | Noise |
| Rotating | quantity | consumption | dB | quantity | consumption | dB |
| speed/rpm | m³/h | W | (A) | m³/h | W | (A) |
| 300 | 1802 | 80 | 30 | 1820 | 76 | 29 |
| 450 | 2835 | 67 | 39 | 2864 | 64 | 38 |
| 540 | 3455 | 81 | 44 | 3490 | 77 | 43 |
| 660 | 4282 | 124 | 50 | 4325 | 118 | 48 |
| 840 | 5522 | 242 | 57 | 5577 | 230 | 55 |

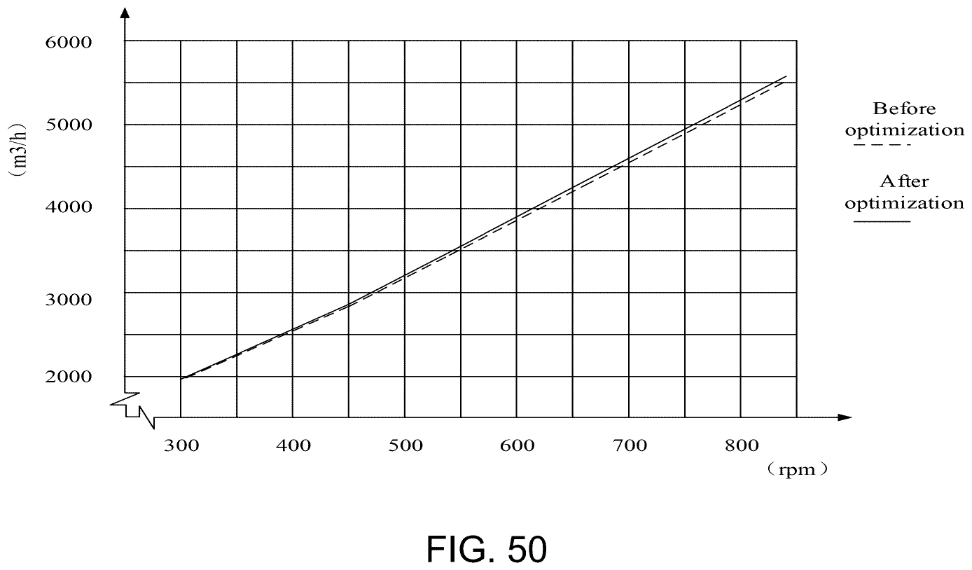

Table 3 is a comparative analysis table of the parameters of the fan 70 before and after optimization, and it can be known from table 3 and FIG. 50 that the air quantity is improved to a certain extent under the condition that the rotating speed of the fan 70 after optimization is the same as that of the fan 70 before optimization.

For example, when the rotating speed is 300 rpm, the air quantity of the fan 70 before optimization is 1802 m³/h, the air quantity of the fan 70 after optimization is 1820 m³/h, and the air quantity of the fan 70 is increased.

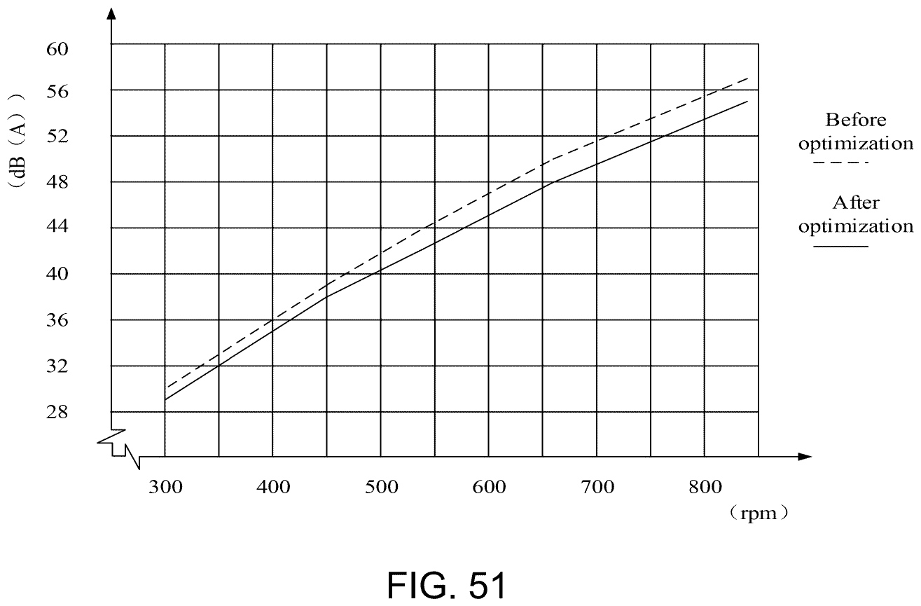

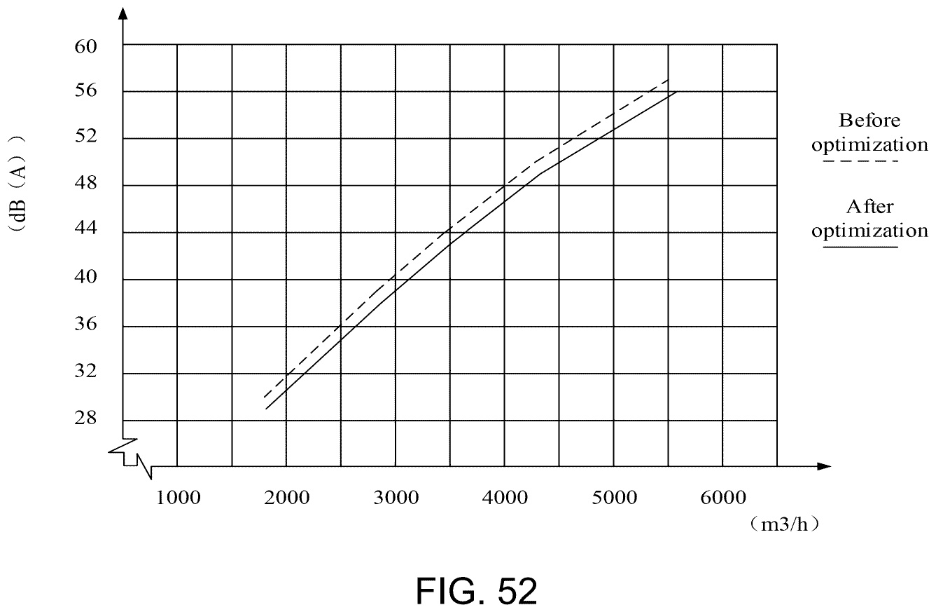

As can be seen from table 3, FIG. 51 and FIG. 52, when the rotating speed is the same, the noise of the fan 70 after optimization is reduced by any value of, for example, [1 dB (A), 3 dB (A)] compared with the noise of the fan 70 before optimization; under the condition of the same air quantity, the noise of the fan 70 after optimization is reduced by any value of [1 dB (A), 2 dB (A)], for example, compared with the noise of the fan 70 before optimization, so that a noise reduction effect of the fan 70 is improved.

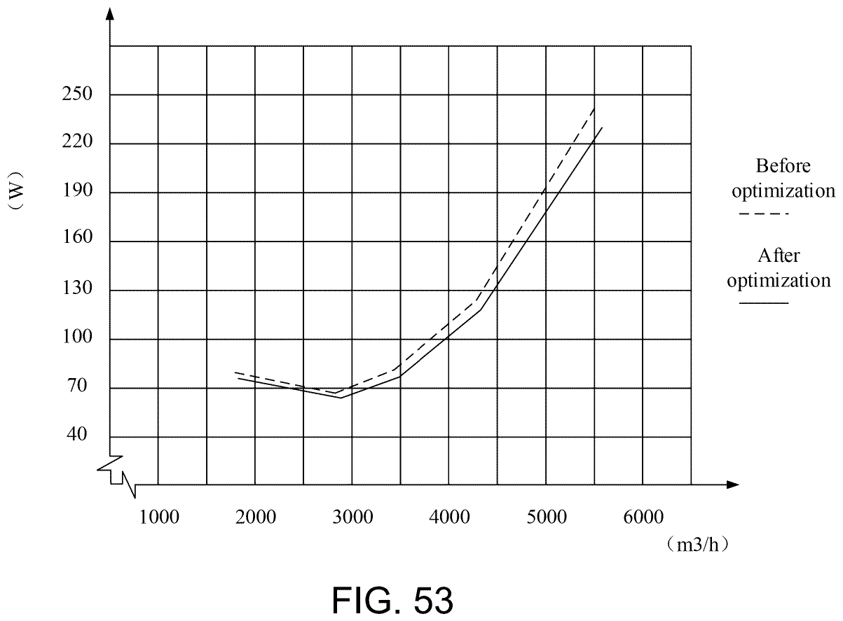

As can be seen from table 3 and FIG. 53, when the air quantity is the same, the power consumption of the fan 70 after optimization is reduced compared with the power consumption of the fan 70 before optimization. Under the condition that the air quantity exceeds 3500 m³/h, the power consumption of the fan 70 after optimization is reduced by 4 W or more compared with the fan 70 before optimization, and the power consumption of the fan 70 is reduced.

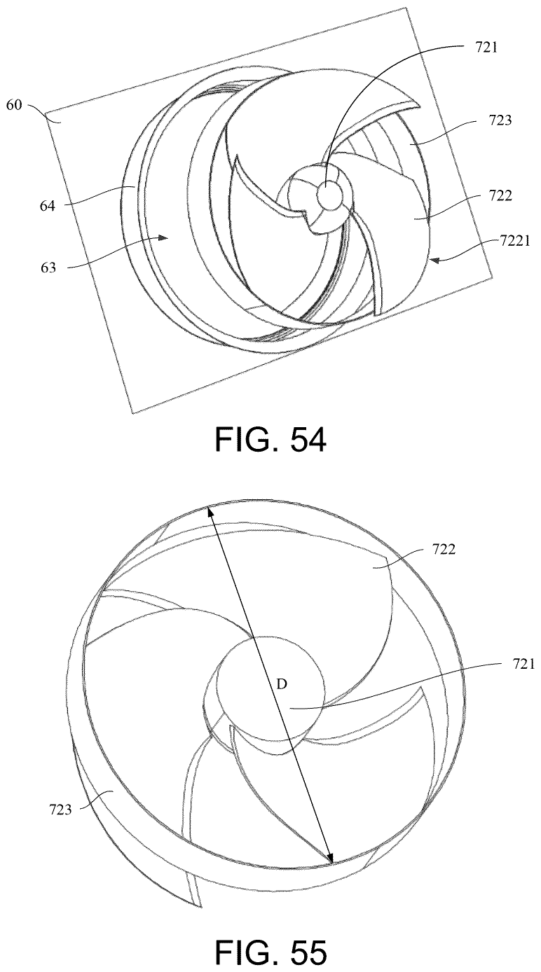

In some embodiments, as shown in FIG. 54 and FIG. 55, the fan blade 72 may further include an air blocking portion 723. The air blocking portion 723 is connected to the first edge portion 7221, and the at least one blade 722 and the fixed portion 721 are arranged on a side of the air blocking portion 723 close to the mounting cavity 61. The air blocking portion 723 may extend along a flow direction of the airflow, for example, the air blocking portion 723 extends along the axial direction of the fan blade 72 along a direction from the motor 71 towards the fixed portion 721. The air blocking portion 723 is spaced apart from the air guide portion 64 along the radial direction of the air guide portion 64, for example, the air blocking portion 723 is spaced apart from the first sub-air guide portion 641 along the radial direction of the first sub-air guide portion 641.

In some embodiments, a side of the air blocking portion 723 away from the mounting cavity 61 extends at least to a side of the at least one blade 722 away from mounting cavity 61 in the axial direction of the fan blade 72. The at least one blade 722 is connected to the air blocking portion 723 through the first edge portion 7221. In this way, in the process that the fan blade 72 rotates to drive the airflow to flow, the air blocking portion 723 can prevent the high-pressure airflow at a pressure surface of the at least one blade 722 from leaking through the gap between the first edge portion 7221 and the air guide portion 64, so that the air supply efficiency of the fan 70 is improved, and the operation power consumption of the fan 70 is reduced. The air blocking portion 723 may also reduce the airflow vortex and pressure pulsation of the at least one blade 722, thus reducing the noise of the fan 70. The air blocking portion 723 can also improve the flocculation and wake conditions of the surface of the at least one blade 722, thus improving the operation efficiency of the fan 70.

In some embodiments, as shown in FIG. 55, the diameter of the fan blade 72 is defined as D, and the diameter of the fan blade 72 may be any value of [500 mm, 700 mm], for example.

In some embodiments, along the radial direction of the fan blade 72, a distance between the air blocking portion 723 and the air guide portion 64 is defined as a first size δ, and the first size δ and the diameter D of the fan blade 72 satisfy: D/70≤δ≤D/50. For example, the first size δ and the diameter D of the fan blade 72 satisfy at least one of: D/70≤δ≤D/65, D/65≤δ≤D/55, or D/55<δ≤D/50. Thus, normal mounting of the fan blade 72 can be ensured, and the air outlet quantity of the fan 70 can also be ensured. In some embodiments, the first size δ is, for example, D/60.

It should be noted that, when the first size δ is smaller than D/70, the gap between the air blocking portion 723 and the air guide portion 64 is smaller than a preset gap, which is inconvenient for mounting the fan blade 72. In the case where the first size δ is larger than D/50, an occupied area of the fan blade 72 relative to the air outlet 63 is small, and the air outlet quantity of the fan 70 is reduced.

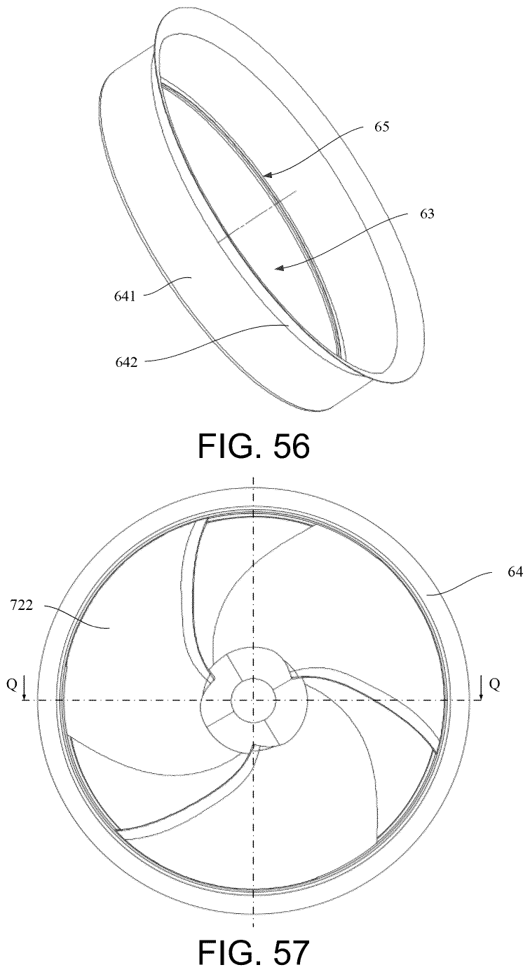

In some embodiments, as shown in FIG. 56 and FIG. 59, the air guide portion 64 further includes a mounting portion 65, and the mounting portion 65 is arranged on a side of the air guide portion 64 close to the mounting cavity 61 and configured to mount the air blocking portion 723. An end of the air blocking portion 723 away from the mounting cavity 61 is inserted into the mounting portion 65, so that the fan blade 72 and the air guide portion 64 can be positioned and mounted conveniently.

In some embodiments, as shown in FIG. 59, the air guide portion 64 further includes a third sub-air guide portion 643, and the third sub-air guide portion 643 is arranged close to the first sub-air guide portion 641 and connected to the first sub-air guide portion 641.

In some embodiments, the air guide portion 64 further includes a fourth sub-air guide portion 644, and the fourth sub-air guide portion 644 is arranged away from the first sub-air guide portion 641 and connected to the third sub-air guide portion 643.

Along the axial direction of the fan blade 72, an end of the first sub-air guide portion 641 close to the leeward side of the fan blade 72, the third sub-air guide portion 643 and the fourth sub-air guide portion 644 define the mounting portion 65, and an opening of the mounting portion 65 is arranged towards the windward side of the fan blade 72.

In some embodiments, as shown in FIG. 59, along the axial direction of the fan blade 72, a distance between the air blocking portion 723 and the third sub-air guide portion 643 is defined as a second size K1, and the second size K1 is, for example, any value of [0, 8].

In some embodiments, as shown in FIG. 59, along the radial direction of the air guide portion 64, a distance between the air blocking portion 723 and the fourth sub-air guide portion 644 is defined as a third size K2, and the third size K2 is, for example, any value of [0, 8].

Thus, during the rotation of the fan blade 72, the air blocking portion 723 can be prevented from contacting and rubbing the third sub-air guide portion 643 and the fourth sub-air guide portion 644, and resistance generated by the rubbing with the air guide portion 64 during the rotation of the fan blade 72 can be avoided.

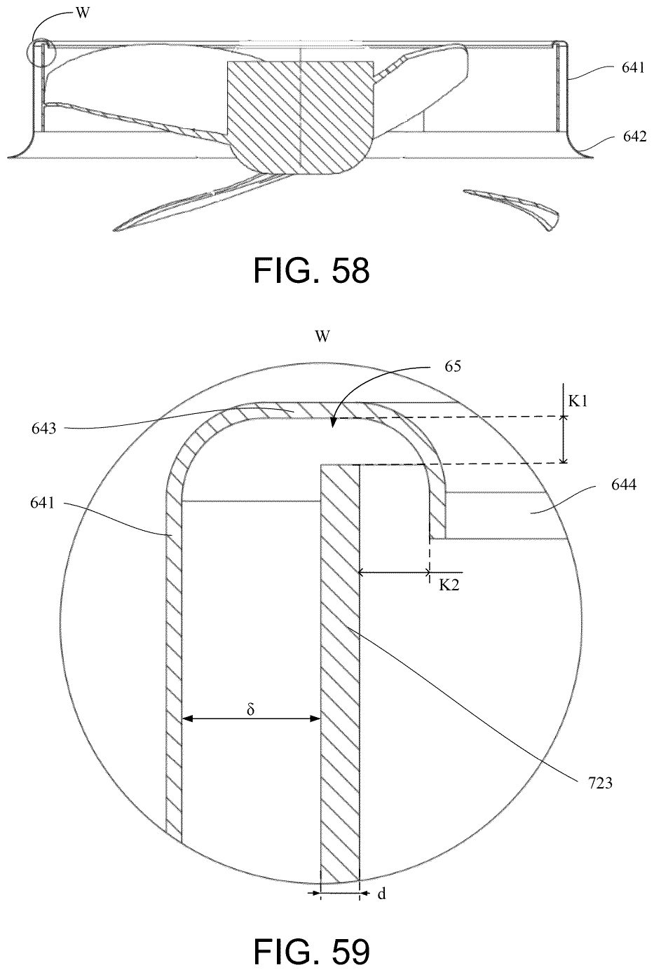

In some embodiments, as shown in FIG. 57, FIG. 58 and FIG. 59, in the radial direction of the fan blade 72, a thickness d of the air blocking portion 723 may have any value of [0.18, 0.258], for example. In this way, structural stability of the fan blade 72 can be guaranteed, a weight of the fan blade 72 can be reduced, and the air outlet efficiency of the fan 70 can be improved.

It should be noted that, when the thickness d of the air blocking portion 723 is smaller than 0.18, the air blocking portion 723 may be deformed by a centrifugal force generated during the rotation of the fan blade 72, so that the air blocking portion 723 may contact the air guide portion 64, thereby increasing rotation resistance and noise of the fan blade 72. Under the condition that the thickness d of the air blocking portion 723 is larger than 0.258, the weight of the fan blade 72 is larger than a preset weight, and the air outlet quantity and the air outlet efficiency of the fan 70 are reduced.

In some embodiments, the third sub-air guide portion 643 is connected to the first sub-air guide portion 641 through a rounded or chamfered structure, for example, so as to reduce the flow resistance of the airflow there.

In some embodiments, the third sub-air guide portion 643 is connected to the fourth sub-air guide portion 644 through a rounded corner structure or chamfered structure, for example, so as to reduce the flow resistance of the airflow there.

In some embodiments, the first size is set to 10 mm, the second and third sizes are set to 1 mm, and the thickness of the air blocking portion 723 is set to 2.5 mm.

Before optimization, the static pressure of the fan 70 is 45 Pa when the rotating speed is 730 rpm, the power consumption of the fan 70 is 176.5 W, and the air outlet quantity at the air outlet 63 is 5480 m³/h, that is, the static pressure efficiency of the fan 70 before optimization is 38%.

After optimization, the static pressure of the fan 70 is 45 Pa when the rotating speed is 730 rpm, the power consumption of the fan 70 is 178 W, and the air outlet quantity at the air outlet 63 is 5800 m³/h, that is, the static pressure efficiency of the fan 70 after optimization is 45%.

It can be learned from the above parameters that by optimizing the fan 70 and the air guide portion 64, the air outlet quantity of the fan 70 is increased at the same rotating speed, the air outlet efficiency is improved, the power consumption is reduced, and the air noise is reduced.

TABLE 4

| | Before optimization | | | After optimization | | |
|---|---|---|---|---|---|---|
| | Air | Power | Noise | Air | Power | Noise |
| Rotating | quantity | consumption | dB | quantity | consumption | dB |
| speed/rpm | m³/h | W | (A) | m³/h | W | (A) |
| 300 | 1802 | 40 | 30 | 1946.16 | 42 | 29 |
| 450 | 2835 | 67 | 39 | 3061.8 | 68.34 | 38 |
| 540 | 3455 | 81 | 44 | 3731.4 | 82.62 | 43 |
| 660 | 4282 | 124 | 50 | 4624.56 | 126.48 | 49 |
| 840 | 5522 | 242 | 57 | 5963.76 | 246.84 | 56 |

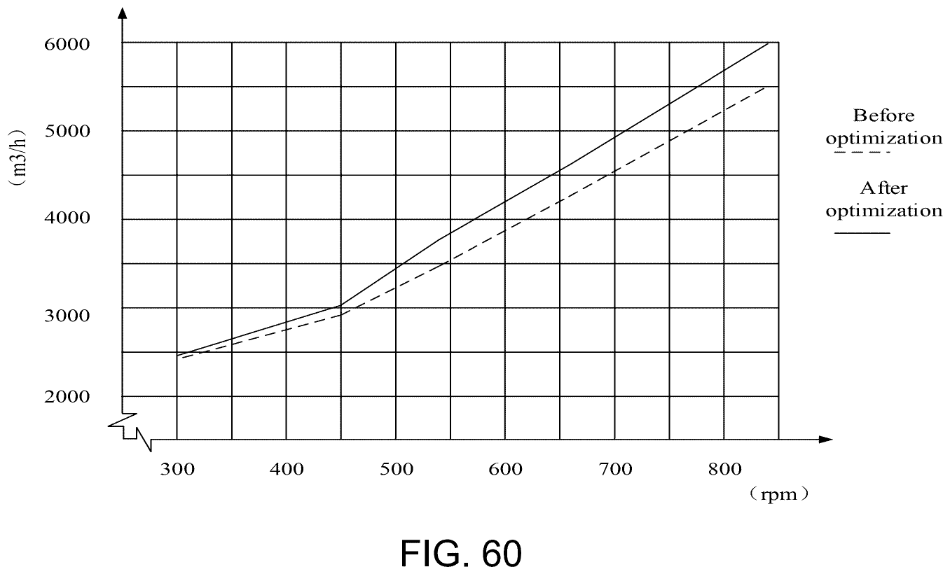

Table 4 is a parameter analysis table before and after optimization of the element chord length of the at least one blade 722 of the fan 70 in the embodiment in which the fan blade 72 includes the air blocking portion 723, and it is understood from table 4 and FIG. 60 that the air quantity is improved to a certain extent under the condition that the rotating speed of the fan 70 after optimization is the same as that of the fan 70 before optimization.

For example, when the rotating speed is 300 rpm, the air quantity of the fan 70 before optimization is 1802 m³/h, the air quantity of the fan 70 after optimization is 1946.16 m³/h, and the air quantity of the fan 70 is increased.

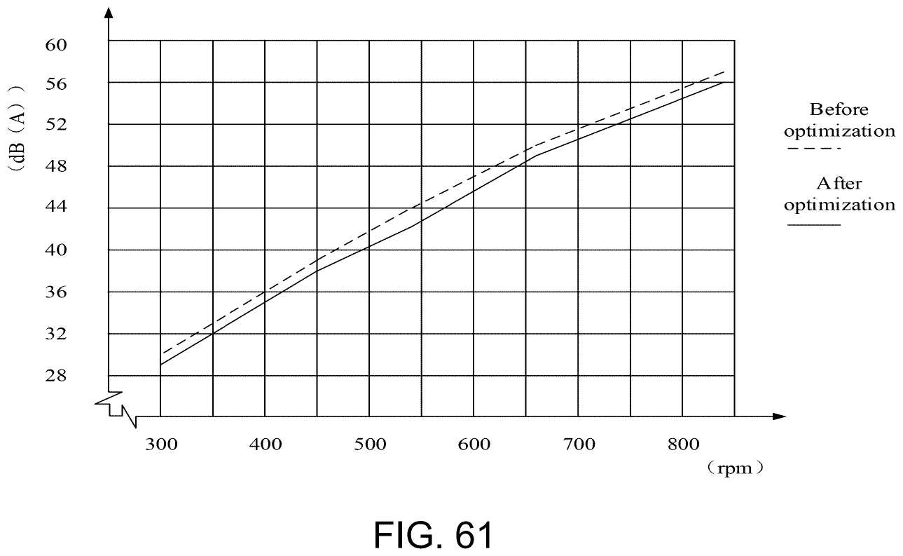

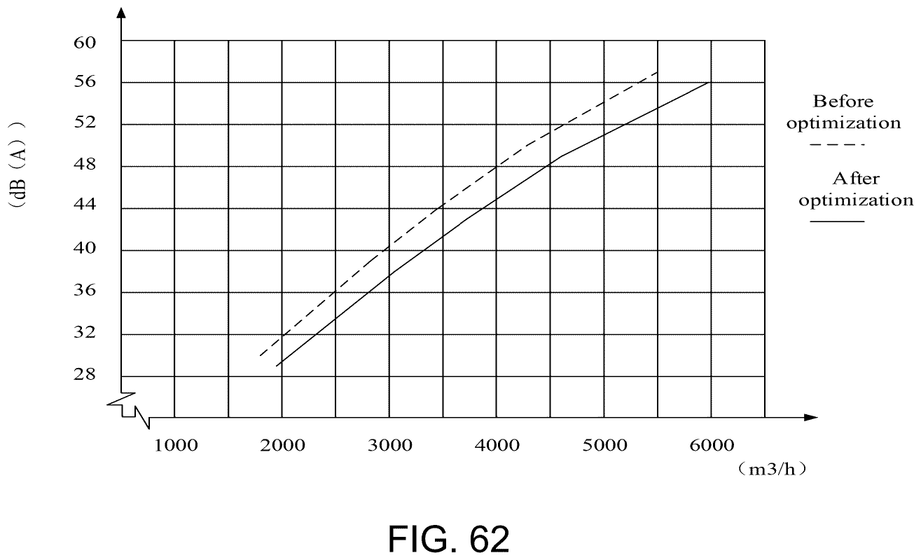

As can be seen from table 4, FIG. 61 and FIG. 62, under the condition of the same rotating speed, the noise of the fan 70 after optimization is reduced by any value of, for example, [1 dB (A), 2 dB (A)] compared with the noise of the fan 70 before optimization; under the condition of the same air quantity, the noise of the fan 70 after optimization is reduced by any value of [2 dB (A), 4 dB (A)], for example, compared with the noise of the fan 70 before optimization, so that a noise reduction effect of the fan 70 is improved.

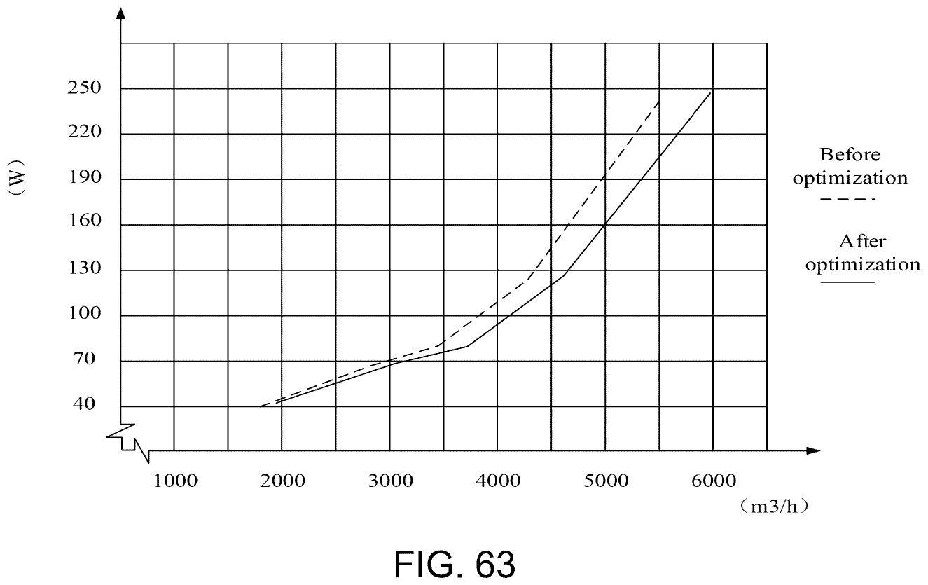

As can be seen from table 4 and FIG. 63, when the air quantity is the same, the power consumption of the fan 70 after optimization is reduced compared with the power consumption of the fan 70 before optimization. Under the condition that the air quantity exceeds 3500 m³/h, the power consumption of the fan 70 after optimization is reduced by 10W or more compared with the fan 70 before optimization, and the power consumption of the fan 70 is reduced.

For example, in the case where the air quantity is 5500 m³/h, the power consumption of the fan 70 before optimization is about 240 W, and the power consumption of the fan 70 after optimization is about 205 W. That is, under the condition that the air quantity is 5500 m³/h, the power consumption of the fan 70 after optimization is reduced by 35 W compared with the fan 70 before optimization, a reduction amplitude is 14.6%, and in this case, the fan 70 meets energy-saving requirements.

It should be noted that the fan 70 and the adaptive air guide portion 64 may be applied to the outdoor unit 200 or the indoor unit 300.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A distance between an end of the first sub-edge portion that is close to the windward side of the at least one blade and an axis of the fixed portion is greater than a distance between an end of the second sub-edge portion that is close to the leeward side of the at least one blade and the axis of the fixed portion.

In some embodiments, the housing further includes an air guide portion which defines an air outlet, and in an axial direction of the air guide portion, the second sub-edge portion extends into the air guide portion.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. There exists a point on the first sub-edge portion, a distance from which to an axis of the fixed portion is greater than a distance from a point on the second sub-edge portion to the axis of the fixed portion.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. The third sub-edge portion extends toward the fixed portion in a direction from the first sub-edge portion to the second sub-edge portion.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A distance between any point on the first sub-edge portion and the axis of the fixed portion is greater than a distance between any point on the second sub-edge portion and the axis of the fixed portion.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. A plane perpendicular to an axis of the fan blade is defined as a cross section of the fan blade, a projection of the first sub-edge portion on the cross section is a first circular arc, a projection of the second sub-edge portion on the cross section is a second circular arc, and the radius of the first circular arc is greater than the radius of the second circular arc.

In some embodiments, an air conditioner is provided. The air conditioner includes an outdoor unit. The outdoor unit includes a housing. The housing includes a vent and an accommodating cavity, and the vent is in communication with the accommodating cavity. The outdoor unit further includes a fan arranged in the accommodating cavity and corresponding to the vent. The fan includes a motor and a fan blade. The fan blade includes a fixed portion and at least one blade, and the at least one blade is connected to an output portion of the motor through the fixed portion. The at least one blade includes a first edge portion arranged on a side of the at least one blade away from the fixed portion. The first edge portion includes a first sub-edge portion, a second sub-edge portion, and a third sub-edge portion. The first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion. The first sub-edge portion includes a first end and a second end, and the second end of the first sub-edge portion is connected to one end of the third sub-edge portion. The second sub-edge portion includes a third end and a fourth end, and the fourth end of the second sub-edge portion is connected to the other end of the third sub-edge portion. A distance between the second end and the axis of the fixed portion is greater than a distance between the third end and the axis of the fixed portion.

The specific features of the air conditioner may be referred to the descriptions above for details, which are not repeated here.

In the foregoing description of the embodiments, the particular features, structures, materials, or characteristics may be combined in any suitable manner in any one or more embodiments or examples.

It will be understood by those skilled in the art that the scope of the disclosure of the present disclosure is not limited to the particular embodiments described above, and that modifications and substitutions of certain elements of the embodiments may be made without departing from the spirit of the disclosure. The scope of the present disclosure is limited by the appended claims.

What is claimed is:

1. An air conditioner, comprising:
an outdoor unit comprising:
a housing comprising a vent and an accommodating cavity, the vent being in communication with the accommodating cavity; and
a fan arranged in the accommodating cavity and corresponding to the vent, wherein the fan comprises:
a motor; and
a fan blade, wherein the fan blade comprises a fixed portion and at least one blade, and the at least one blade is connected to an output portion of the motor through the fixed portion;
wherein the at least one blade comprises a first edge portion arranged on a side of the at least one blade away from the fixed portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion; and
a distance between any point on the first sub-edge portion and an axis of the fixed portion is greater than a distance between any point on the second sub-edge portion and the axis of the fixed portion.

2. The air conditioner of claim 1, wherein a plane perpendicular to an axis of the fan blade is defined as a cross section of the fan blade, a projection of the first sub-edge portion on the cross section is a first circular arc, and a projection of the second sub-edge portion on the cross section is a second circular arc.

3. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion; and
a plane perpendicular to an axis of the fan blade is defined as a cross section of the fan blade, a radial size of a projection of the first sub-edge portion on the cross section of the fan blade increases in a direction from the second end to the first end.

4. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion; and
a plane perpendicular to an axis of the fan blade is defined as a cross section of the fan blade, a radial size of a projection of the second sub-edge portion on the cross section of the fan blade increases in a direction from the third end to the fourth end.

5. The air conditioner of claim 1, wherein
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion;
a distance between the first end and the axis of the fixed portion is greater than or equal to a distance between the second end and the axis of the fixed portion; and
a distance between the third end and the axis of the fixed portion is less than or equal to a distance between the fourth end and the axis of the fixed portion.

6. The air conditioner of claim 1, wherein the third sub-edge portion comprises at least one of a first curve, a second curve, or a third curve.

7. The air conditioner of claim 6, wherein along a direction from the first sub-edge portion to the second sub-edge portion, the third sub-edge portion comprises the first curve, the second curve, and the third curve that are connected in sequence;
wherein an end of the first curve away from the second curve is connected to the first sub-edge portion, an end of the third curve away from the second curve is connected to the second sub-edge portion, and the first curve is connected to the third curve through the second curve.

8. The air conditioner of claim 6, wherein along a direction from the first sub-edge portion to the second sub-edge portion, the third sub-edge portion comprises the first curve and the second curve that are connected in sequence, and an end of the first curve away from the second curve is connected to the first sub-edge portion; or
along the direction from the first sub-edge portion to the second sub-edge portion, the third sub-edge portion comprises the first curve and the third curve that are connected in sequence, and an end of the first curve away from the third curve is connected to the first sub-edge portion; or
along the direction from the first sub-edge portion to the second sub-edge portion, the third sub-edge portion comprises the second curve and the third curve that are connected in sequence, and an end of the second curve away from the third curve is connected to the first sub-edge portion.

9. The air conditioner of claim 1, wherein the housing further comprises an air guide portion which defines an air outlet; and
in an axial direction of the air guide portion, the second sub-edge portion extends into the air guide portion.

10. The air conditioner of claim 9, wherein a difference between an inner diameter of the air guide portion and a distance between the second sub-edge portion and the axis of the fixed portion is any value of [6 mm, 12 mm].

11. The air conditioner of claim 1, wherein a difference between a distance between the first sub-edge portion and the axis of the fixed portion and a distance between the second sub-edge portion and the axis of the fixed portion is any value of [2 mm, 20 mm].

12. The air conditioner of claim 1, wherein
a plane perpendicular to an axis of the fan blade is defined as a cross section of the fan blade,
along an axial direction of the fan blade, a perpendicular projection of the first edge portion on the cross section of the fan blade is defined as a first arc;
an included angle formed by connection lines between two ends of the first arc and the axis of the fan blade is defined as a first arc center angle β;
an included angle formed by connection lines between two ends of a perpendicular projection of the third sub-edge portion on the cross section of the fan blade and the axis of the fan blade is defined as a third sub-arc center angle α3, and a ratio of the third sub-arc center angle α3 to the first arc center angle β is any value of [4%, 8%].

13. The air conditioner of claim 1, wherein the third sub-edge portion extends toward the fixed portion in a direction from the first sub-edge portion to the second sub-edge portion.

14. An air conditioner, comprising:
an outdoor unit comprising:
a housing comprising a vent and an accommodating cavity, the vent being in communication with the accommodating cavity; and
a fan arranged in the accommodating cavity and corresponding to the vent, wherein the fan comprises:
a motor; and
a fan blade, wherein the fan blade comprises a fixed portion and at least one blade, and the at least one blade is connected to an output portion of the motor through the fixed portion;
wherein the at least one blade comprises a first edge portion arranged on a side of the at least one blade away from the fixed portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion;
a plane perpendicular to an axis of the fan blade is defined as a cross section of the fan blade, a projection of the first sub-edge portion on the cross section is a first circular arc, a projection of the second sub-edge portion on the cross section is a second circular arc, and a radius of the first circular arc is greater than a radius of the second circular arc.

15. The air conditioner of claim 14, wherein the first circular arc and the second circular arc are concentric.

16. The air conditioner of claim 14, wherein the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion;
a distance between the first end and the axis of the fixed portion is greater than or equal to a distance between the second end and the axis of the fixed portion; and
a distance between the third end and the axis of the fixed portion is less than or equal to a distance between the fourth end and the axis of the fixed portion.

17. The air conditioner of claim 14, wherein the third sub-edge portion extends toward the fixed portion in a direction from the first sub-edge portion to the second sub-edge portion.

18. An air conditioner, comprising:
an outdoor unit comprising:
a housing comprising a vent and an accommodating cavity, the vent being in communication with the accommodating cavity; and
a fan arranged in the accommodating cavity and corresponding to the vent, wherein the fan comprises:
a motor; and
a fan blade, wherein the fan blade comprises a fixed portion and at least one blade, and the at least one blade is connected to an output portion of the motor through the fixed portion;
wherein the at least one blade comprises a first edge portion arranged on a side of the at least one blade away from the fixed portion, and the first edge portion comprises a first sub-edge portion, a second sub-edge portion, and a third sub-edge portion;
the first sub-edge portion is disposed at an end of the first edge portion that is close to a windward side of the at least one blade, the second sub-edge portion is disposed at an end of the first edge portion that is close to a leeward side of the at least one blade, and the third sub-edge portion is connected between the first sub-edge portion and the second sub-edge portion;
the first sub-edge portion comprises a first end and a second end, and the second end of the first sub-edge portion is connected to one end of the third sub-edge portion;
the second sub-edge portion comprises a third end and a fourth end, and the fourth end of the second sub-edge portion is connected to the other end of the third sub-edge portion; and
a distance between the second end and the axis of the fixed portion is greater than a distance between the third end and the axis of the fixed portion.

19. The air conditioner of claim 18, wherein a plane perpendicular to an axis of the fan blade is defined as a cross section of the fan blade, a projection of the first sub-edge portion on the cross section is a first circular arc, and a projection of the second sub-edge portion on the cross section is a second circular arc.

20. The air conditioner of claim 18, wherein the third sub-edge portion extends toward the fixed portion in a direction from the first sub-edge portion to the second sub-edge portion.
